(19) United States
(12) Patent Application Publication
(10) Pub. No.: US 2012/0012762 A1
(43) Pub. Date: Jan. 19, 2012

(54) LASER DEVICE, LASER SYSTEM, AND EXTREME ULTRAVIOLET LIGHT GENERATION APPARATUS

(76) Inventors: Krzysztof Nowak, Tochigi (JP); Masato Moriya, Tochigi (JP); Osamu Wakabayashi, Kanagawa (JP)

(21) Appl. No.: 13/121,340

(22) PCT Filed: Mar. 2, 2011
(86) PCT No.: PCT/JP2011/055440

§ 371 Date: Jul. 12, 2011

(30) Foreign Application Priority Data
Mar. 4, 2010 (JP) 2010-048289
Jan. 7, 2011 (JP) 2011-002471

(51) Int. Cl. G21K 5/00; F21V 8/00; H01S 3/10; G02B 5/18

(52) U.S. Cl. 250/504 R; 362/235; 362/553; 359/333

(57) ABSTRACT

A laser device may include: a diffraction grating; and a plurality of semiconductor lasers disposed such that laser beams outputted therefrom are incident on the diffraction grating and at least one of diffraction beams of each laser beam travels in a predetermined direction.

### CROSS-REFERENCE TO RELATED APPLICATIONS

The present application claims priority from Japanese Patent Application No. 2010-048289 filed on Mar. 4, 2010, and Japanese Patent Application No. 2011-002471 filed on Jan. 7, 2011, the disclosures of each of which are incorporated herein by reference in their entirety.

### BACKGROUND

1. Technical Field

The present disclosure relates to laser devices, laser systems, and extreme ultraviolet (EUV) light generation apparatuses, and in particular to a laser device capable of outputting a laser beam of multiple wavelengths that differ from one another, to a laser system including the laser device, and to an extreme ultraviolet light generation apparatus including the laser system.

2. Description of Related Art

In recent years, as semiconductor processes have become finer, photolithography has been making rapid progress toward finer fabrication. In the next generation, microfabrication at 70 nm to 45 nm, further, microfabrication at 32 nm and beyond will be required. Accordingly, in order to fulfill the requirement for microfabrication at 32 nm and beyond, for example, an exposure apparatus is expected to be developed, in which an EUV light generation apparatus for generating EUV light having a wavelength of approximately 13 nm is combined with reduced projection reflective optics.

As an EUV light generation apparatus, three kinds of light generation apparatuses are generally known, which include an LPP (laser produced plasma) type light generation apparatus using plasma generated by irradiating a target material with a laser beam, a DPP (discharge produced plasma) type light generation apparatus using plasma generated by electric discharge, and an SR (synchrotron radiation) type light generation apparatus using orbital radiation.

### SUMMARY

A laser device in accordance with one aspect of this disclosure may include: a diffraction grating; and a plurality of semiconductor lasers disposed such that laser beams outputted therefrom are incident on the diffraction grating and at least one of diffraction beams of each laser beam travels in a predetermined direction.

A laser device in accordance with another aspect of this disclosure may include: at least one optical element having a focal position; a diffraction grating disposed substantially at the focal position of the at least one optical element; and a plurality of semiconductor lasers disposed such that laser beams outputted therefrom are incident on the at least one optical element, the laser beams outputted from the at least one optical element are incident on the diffraction grating, and at least one of diffraction beams of each laser beam travels in a predetermined direction.

A laser device in accordance with yet another aspect of this disclosure may include: at least one optical element having a focal position; a diffraction grating disposed substantially at the focal position of the at least one optical element; a plurality of semiconductor lasers; and a plurality of optical fibers each having one end thereof being connected to a corresponding output end of the plurality of the semiconductor lasers, the plurality of the optical fibers being disposed such that laser beams outputted therefrom are incident on the at least one optical element, the laser beams outputted from the at least one optical element are incident on the diffraction grating, and at least one of diffraction beams of each laser beam travels in a predetermined direction.

A laser system in accordance with one aspect of this disclosure may include: a laser device including a diffraction grating, and a plurality of semiconductor lasers disposed such that laser beams outputted therefrom are incident on the diffraction grating and at least one of diffraction beams of each laser beams travels in a predetermined direction; and at least one amplifier disposed downstream of the laser device for amplifying a laser beam outputted from the laser device.

A laser system in accordance with one aspect of this disclosure may include: a laser device including at least one optical element having a focal position, a diffraction grating disposed substantially at the focal position of the at least one optical element, and a plurality of semiconductor lasers disposed such that laser beams outputted therefrom are incident on the at least one optical element, the laser beams outputted from the at least one optical element are incident on the diffraction grating, and at least one of diffraction beams of each laser beam travels in a predetermined direction; and at least one amplifier disposed downstream of the laser device for amplifying a laser beam outputted from the laser device.

A laser system in accordance with one aspect of this disclosure may include: a laser device including at least one optical element having a focal position, a diffraction grating disposed substantially at the focal position of the at least one optical element, a plurality of semiconductor lasers, and a plurality of optical fibers each having one end thereof being connected to a corresponding output end of the plurality of the semiconductor lasers, the plurality of the optical fibers being disposed such that laser beams outputted therefrom are incident on the at least one optical element, the laser beams outputted from the at least one optical element are incident on the diffraction grating, and at least one of diffraction beams of each laser beam travels in a predetermined direction; and at least one amplifier disposed downstream of the laser device for amplifying a laser beam outputted from the laser device.

An extreme ultraviolet light generation apparatus in accordance with one aspect of this disclosure may include; the laser system including a laser device which has a diffraction grating and a plurality of semiconductor lasers, the plurality of the semiconductor lasers being disposed such that laser beams outputted therefrom are incident on the diffraction grating and at least one of diffraction beams of each laser beams travels in a predetermined direction, and at least one amplifier disposed downstream of the laser device for amplifying a laser beam outputted from the laser device; a chamber provided with an inlet for introducing a laser beam outputted from the laser system into the chamber; a focusing optical system for focusing the laser beam in a predetermined region inside the chamber; a target supply unit provided to the chamber for supplying a target material to the predetermined region inside the chamber; and a collector mirror disposed inside the chamber for collecting light of a predetermined wavelength emitted when the target material is irradiated with the laser beam in the predetermined region.

An extreme ultraviolet light generation apparatus in accordance with one aspect of this disclosure may include; the laser system including a laser device which has at least one optical element having a focal position, a diffraction grating disposed substantially at the focal position of the at least one optical element, and a plurality of semiconductor lasers, the plurality of the semiconductor devices being disposed such that laser beams outputted therefrom are incident on the at least one optical element, the laser beams outputted from the at least one optical element are incident on the diffraction grating, and at least one of diffraction beams of each laser beam travels in a predetermined direction, and at least one amplifier disposed downstream of the laser device for amplifying a laser beam outputted from the laser device; a chamber provided with an inlet for introducing a laser beam outputted from the laser system into the chamber; a focusing optical system for focusing the laser beam in a predetermined region inside the chamber; a target supply unit provided to the chamber for supplying a target material to the predetermined region inside the chamber; and a collector mirror disposed inside the chamber for collecting light of a predetermined wavelength emitted when the target material is irradiated with the laser beam in the predetermined region.

An extreme ultraviolet light generation apparatus in accordance with one aspect of this disclosure may include; the laser system including a laser device which has at least one optical element having a focal position, a diffraction grating disposed substantially at the focal position of the at least one optical element, a plurality of semiconductor lasers, and a plurality of optical fibers each having one end thereof being connected to a corresponding output end of the plurality of the semiconductor lasers, the plurality of the optical fibers being disposed such that laser beams outputted therefrom are incident on the at least one optical element, the laser beams outputted from the at least one optical element are incident on the diffraction grating, and at least one of diffraction beams of each laser beam travels in a predetermined direction, and at least one amplifier disposed downstream of the laser device for amplifying a laser beam outputted from the laser device; a chamber provided with an inlet for introducing a laser beam outputted from the laser system into the chamber; a focusing optical system for focusing the laser beam in a predetermined region inside the chamber; a target supply unit provided to the chamber for supplying a target material to the predetermined region inside the chamber; and a collector mirror disposed inside the chamber for collecting light of a predetermined wavelength emitted when the target material is irradiated with the laser beam in the predetermined region.

An extreme ultraviolet light generation apparatus in accordance with one aspect of this disclosure may include; the laser system including a laser device which has a diffraction grating, and a plurality of semiconductor lasers disposed such that laser beams outputted therefrom are incident on the diffraction grating and at least one of diffraction beams of each laser beams travels in a predetermined direction, at least one of the plurality of the amplifiers being a regenerative amplifier, and at least one amplifier disposed downstream of the laser device for amplifying a laser beam outputted from the laser device, the at least one amplifier including a plurality of amplifiers; a chamber provided with an inlet for introducing a laser beam outputted from the laser system into the chamber; a focusing optical system for focusing the laser beam in a predetermined region inside the chamber; a target supply unit provided to the chamber for supplying a target material to the predetermined region inside the chamber; and a collector mirror disposed inside the chamber for collecting light of a predetermined wavelength emitted when the target material is irradiated with the laser beam in the predetermined region.

These and other objects, features, aspects, and advantages of the present disclosure will become apparent to those skilled in the art from the following detailed description, which, taken in conjunction with the annexed drawings, discloses preferred embodiments of the present disclosure.

### BRIEF DESCRIPTION OF THE DRAWINGS

FIG. 1 schematically illustrates a configuration of a master oscillator system and a regenerative amplifier in accordance with a first embodiment of this disclosure.

FIG. 2 schematically illustrates plus/minus m-th order diffraction beams of a beam incident on a beam-combining grating with an incident angle β in accordance with the first embodiment of this disclosure.

FIG. 3 schematically illustrates a configuration of the master oscillator system in accordance with the first embodiment of this disclosure.

FIG. 4 schematically illustrates a configuration of an EUV light generation apparatus in accordance with the first embodiment of this disclosure.

FIG. 5 schematically illustrates plus/minus m-th order diffraction beams of a beam incident on a beam-combining grating with an incident angle β=0° in accordance with a second embodiment of this disclosure.

FIG. 6A schematically illustrates zeroth to plus/minus second order diffraction beams of each laser beam incident on the beam-combining grating with an incident angle β=0° in accordance with the second embodiment of this disclosure.

FIG. 6B schematically illustrates a configuration of a master oscillator system in accordance with the second embodiment of this disclosure.

FIG. 7 is a sectional view of an exemplary transmissive diffraction grating configured such that a beam that passes through a mesa-shaped section thereof and a beam that passes through a slit thereof have a phase difference of π.

FIG. 8A schematically illustrates plus/minus first order diffraction beams of a beam incident on a beam-combining grating with an incident angle β=0° in accordance with a modification of the second embodiment of this disclosure.

FIG. 8B schematically illustrates a configuration of a master oscillator system in accordance with the modification of the second embodiment of this disclosure.

FIG. 9 schematically illustrates plus/minus m-th order diffraction beams of a beam incident on a beam-combining grating with an incident angle β in accordance with a third embodiment of this disclosure.

FIG. 10A schematically illustrates zeroth to plus/minus second order diffraction beams of each laser beam incident on the beam-combining grating with an incident angle β in accordance with the third embodiment of this disclosure.

FIG. 10B schematically illustrates a configuration of a master oscillator system in accordance with the third embodiment of this disclosure.

FIG. 11 is a sectional view of a beam-combining grating in accordance with a modification of the third embodiment of this disclosure, taken along a plane perpendicular to a direction of slits formed on a diffraction surface of the beam-combining grating.

FIG. 12 schematically illustrates plus/minus m-th order diffraction beams of a beam incident on a beam-combining grating with an incident angle 0° in accordance with a fourth embodiment of this disclosure.

FIG. 13A schematically illustrates zeroth to plus/minus second order diffraction beams of each laser beam incident on the beam-combining grating with an incident angle β=0° in accordance with the fourth embodiment of this disclosure.

FIG. 13B schematically illustrates a configuration of a master oscillator system in accordance with the fourth embodiment of this disclosure.

FIG. 14 shows a beam intensity spectrum in a case where a laser beam is diffracted by a reflective diffraction grating.

FIG. 15 schematically illustrates a configuration of a master oscillator system in accordance with a fifth embodiment of this disclosure.

FIG. 16 is a sectional view schematically illustrating a configuration of a master oscillator system in accordance with a sixth embodiment of this disclosure.

FIG. 17 schematically illustrates a configuration of a master oscillator system in accordance with a seventh embodiment of this disclosure.

FIG. 18 schematically illustrates a configuration of a master oscillator system in accordance with an eighth embodiment of this disclosure.

FIG. 19 schematically illustrates zeroth and plus/minus first order diffraction beams of a beam incident on a DOE with an incident angle β=0° in accordance with a ninth embodiment of this disclosure.

FIG. 20 schematically illustrates an arrangement of plus/minus first order diffraction beams that appear on a plane parallel with a diffraction surface of the DOE in accordance with the ninth embodiment of this disclosure.

FIG. 21A schematically illustrates zeroth to plus/minus first order diffraction beams of each laser beam incident on the DOE with an incident angle β=0° in accordance with the ninth embodiment of this disclosure.

FIG. 21B schematically illustrates a configuration of a master oscillator system in accordance with the ninth embodiment of this disclosure.

FIG. 22A schematically illustrates zeroth and plus/minus first order diffraction beams of a laser beam incident on a DOE with an incident angle β=0° in accordance with a tenth embodiment of this disclosure.

FIG. 22B schematically illustrates a configuration of a master oscillator system in accordance with the tenth embodiment of this disclosure.

FIG. 23A schematically illustrates zeroth and plus/minus first order diffraction beams of a laser beam incident on a DOE with an incident angle β in accordance with an eleventh embodiment of this disclosure.

FIG. 23B schematically illustrates a configuration of a master oscillator system in accordance with the eleventh embodiment of this disclosure.

FIG. 24 schematically illustrates a configuration of a master oscillator system in accordance with a twelfth embodiment of this disclosure.

FIG. 25 schematically illustrates a configuration of a master oscillator system in accordance with a thirteenth embodiment of this disclosure.

FIG. 26 schematically illustrates a configuration of a master oscillator system in accordance with a fourteenth embodiment of this disclosure.

FIG. 27 shows a relationship between gain bandwidths of a CO₂ gas gain medium and selected wavelength bands of a grating in accordance with a fifteenth embodiment of this disclosure.

FIG. 28 shows the intensity of amplified pulsed laser beams, which is obtained based on the relationship shown in FIG. 27.

FIG. 29 shows an exemplary relationship between the gain bandwidths and laser beams outputted from semiconductor lasers in accordance with the fifteenth embodiment of this disclosure.

FIG. 30 shows the intensity of amplified pulsed laser beams, which is obtained based on the exemplary relationship shown in FIG. 29.

FIG. 31 shows an exemplary relationship between the gain bandwidths and laser beams outputted from semiconductor lasers in accordance with the sixteenth embodiment of this disclosure.

FIG. 32 shows the intensity of amplified pulsed laser beams obtained based on the exemplary relationship shown in FIG. 31.

FIG. 33 shows an exemplary relationship between the gain bandwidths and laser beams outputted from semiconductor lasers in accordance with a seventeenth embodiment of this disclosure.

FIG. 34 is a timing chart illustrating operation in accordance with the seventeenth embodiment.

FIG. 35 shows the intensity of amplified pulsed laser beams, which is obtained based on the exemplary relationship shown in FIG. 33.

FIG. 36 is a timing chart illustrating operation in accordance with a eighteenth embodiment of this disclosure.

### DESCRIPTION OF PREFERRED EMBODIMENTS

The inventors have found the following problems. One of the problems is that it was difficult to control the pulse shape, the intensity, and so forth, of a laser beam to be outputted. More specifically, when a master oscillator serves as a resonator having an excited CO₂ gas as a gain medium, if an etalon is disposed inside the resonator, it is difficult to control the intensity of an outputted laser beam at each wavelength separately.

Another problem is that when a laser device in which a solid-state laser and a nonlinear crystal are combined is used for a master oscillator of a driver laser, the laser device tends to be increased in size for the following reasons. One of the reasons is that when a laser beam having a broad wavelength spectrum is amplified in a power amplifier having an excited CO₂ gas as a gain medium, the laser beam is only partially amplified at wavelengths where the wavelengths of the laser beam overlap the gain bandwidths of the gain medium. In other words, the laser beam is not amplified at wavelengths which do not overlap the gain bandwidths of the gain medium. That is, the gain efficiency (ratio of the energy of an amplified laser beam with respect to the energy of a laser beam which is inputted to an amplifier) is often low. Accordingly, a laser device in which a high-power solid-state laser and a nonlinear crystal are combined is required in order to obtain a laser beam amplified to a desired energy level. According to the following embodiments, controllability of the intensity and of the pulse width of a laser beam is improved. Further, a laser device can be reduced in size.

Hereinafter, embodiments for implementing this disclosure will be described in detail with reference to the drawings. In the description to follow, each drawing merely illustrates shape, size, positional relationship, or the like, of members schematically to the extent that enables the content of this disclosure to be understood. Accordingly, this disclosure is not limited to the shape, the size, the positional relationship, or the like, of the members illustrated in each drawing. In order to simplify the drawings, part of hatching along a section is omitted. Further, numerical values indicated hereafter are merely preferred examples of this disclosure. Accordingly, this disclosure is not limited to the indicated numerical values. It should be noted that, in this specification, a laser device is defined as a master oscillator system. The master oscillator system oscillates a multi-line (multiple wavelengths) seed beam.

### First Embodiment

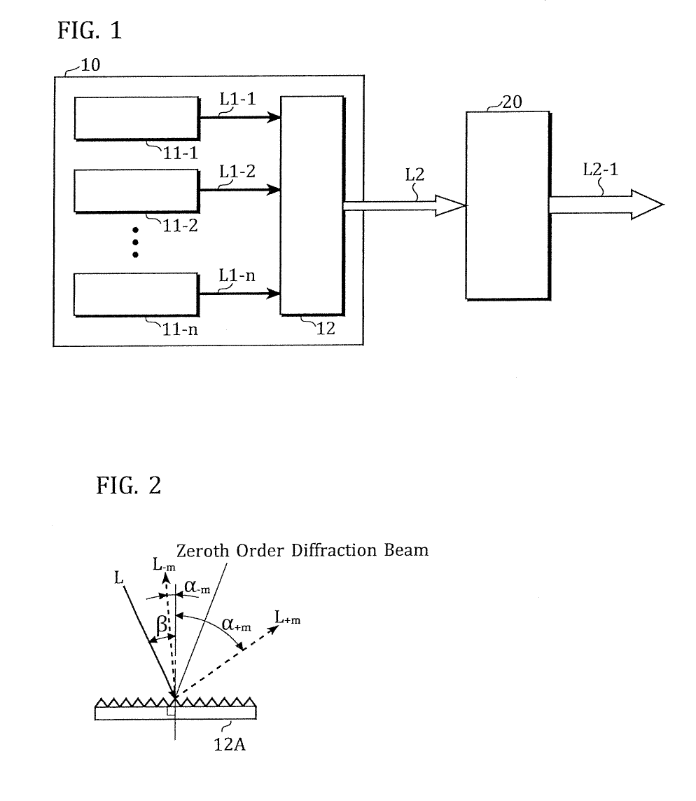

A master oscillator system serving as a laser device, a driver laser including the master oscillator system, and an EUV light generation apparatus in accordance with a first embodiment of this disclosure will be described in detail with reference to the drawings. FIG. 1 schematically illustrates a configuration of a master oscillator system and a regenerative amplifier in accordance with the first embodiment.

As shown in FIG. 1, a master oscillator system 10 in accordance with the first embodiment may include a plurality of semiconductor lasers 11-1 through 11-n serving as an oscillator, and a beam combiner 12 that combines at least parts of laser beams L1-1 through L1-n outputted from the semiconductor lasers 11-1 through 11-n respectively. The semiconductor lasers 11-1 through 11-n respectively output the pulsed laser beams L1-1 through L1-n, the pulsed laser beams L1-1 through L1-n each having a central wavelength that is contained in gain bandwidths of a gain medium containing CO₂ gas of amplifiers (such as, regenerative amplifier 20, amplifier 30, pre-amplifier PA, and main amplifier MA).

In the first embodiment, the laser beams L1-1 through L1-n are generated respectively by the semiconductor lasers 11-1 through 11-n, the laser beams L1-1 through L1-n each having a central wavelength that is contained in the gain bandwidths of the gain medium containing CO₂ gas of the amplifiers. As a result, the wavelength controllability of the master oscillator system 10 and the gain efficiency at downstream amplification stages can be improved with ease. Further, controlling current inputted to each of the semiconductor lasers 11-1 through 11-n enables the intensity and the pulse width of the laser beams L1-1 through L1-n outputted from the respective semiconductor lasers 11-1 through 11-n to be controlled more easily. Here, a quantum cascade laser (QCL) can be cited as an example of a semiconductor laser that oscillates at least one of the gain bandwidths of the gain medium containing CO₂ gas.

The laser beams L1-1 through L1-n outputted from the respective semiconductor lasers 11-1 through 11-n are at least partially combined by the beam combiner 12, and thereafter is outputted as a combined laser beam L2. It should be noted that the combined laser beam L2 is a laser beam containing a plurality of wavelength components (L1-1 through L1-n). The combined laser beam outputted from the master oscillator system 10 enters the regenerative amplifier 20 disposed downstream thereof in the beam route. As will be described in detail later, the regenerative amplifier 20 includes, as a gain medium, a mixed gas containing CO₂ gas. Accordingly, the regenerative amplifier 20 can amplify the combined laser beam L2 at multi-line in the plurality of the gain bandwidths of the gain medium, the combined laser beam L2 including the plurality of the wavelength components (L1-1 through L1-n) each corresponding to one of the gain bandwidths (for example, seven gain bandwidths). The combined laser beam L2 having been amplified at multi-line is then outputted as an amplified laser beam L2-1.

Here, the beam combiner 12 in accordance with the first embodiment will be described. In the first embodiment, a beam-combining grating 12A, which is a reflective diffraction grating, is used as the beam-combining grating 12. As shown in FIG. 2, the beam-combining grating 12A diffracts, based on the wavelength selectivity (dispersion) thereof, for example, minus m-th order diffraction beam L₋ₘ (m is a positive integer, for example, 1) of a beam L that is incident thereon with an incident angle β with a diffraction angle α dependent on a wavelength λ of the incident beam L. At this time, the relationship among an incident angle R, the diffraction angle α, and the wavelength λ satisfies the formula 1 below. Note that FIG. 2 schematically illustrates plus/minus m-th order diffraction beams of a beam incident on the beam-combining grating with an incident angle β in accordance with the first embodiment. Further, in the formula 1, m represents the order of the diffraction beams to be combined, and N represents the number of slits (per millimeter) in a unit length on the diffraction grating.

Nmλ=sin β±sin α (Formula 1)

The formula 1 above may be satisfied even when the incident angle β and the diffraction angle α are interchanged. That is, a beam incident on the diffraction grating with the incident angle β is diffracted with the diffraction angle α, and a beam incident on the diffraction grating with the incident angle α is diffracted with the diffraction angle β.

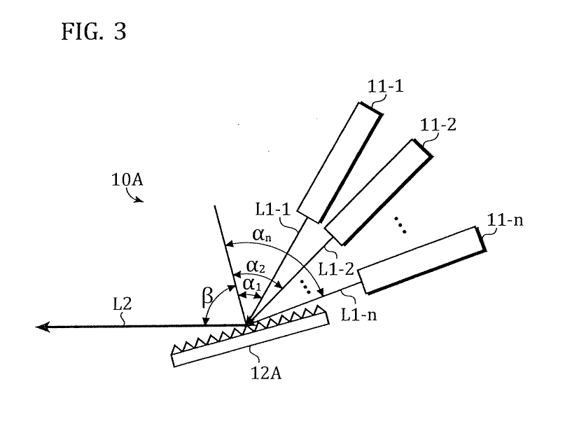

Accordingly, as shown in FIG. 3, a master oscillator system 10A in accordance with the first embodiment is configured such that the semiconductor lasers 11-1 through 11-n are disposed with respect to the beam-combining grating 12A so that the diffraction beams of the same order (for example, minus first order diffraction beam) of the laser beams L1-1 through L1-n outputted from the plurality of the respective semiconductor lasers 11-1 through 11-n are diffracted in the same direction and with the same diffraction angle β. Here, the semiconductor lasers 11-1 through 11-n are disposed with respect to the grating 12A so as to satisfy the formulae 2 below. FIG. 3 schematically illustrates a configuration of the master oscillator system in accordance with the first embodiment. In the formulae 2 below, λ₁ through λₙ represent the central wavelengths of the respective laser beams L1-1 through L1-n, β represents the diffraction angle, and α₁ through αₙ represent the incident angles of the respective semiconductor laser beams L1-1 through L1-n.

$$Nm {λ}_{1} = sin β \pm sin {α}_{1} \\ Nm {λ}_{2} = sin β \pm sin {α}_{2} \\ … \\ Nm {λ}_{n} = sin β \pm sin {α}_{n} \qquad ( Formulae 2 )$$

In the first embodiment, disposing the semiconductor lasers 11-1 through 11-n with respect to the reflective beam-combining grating 12A (beam combiner 12) in the above-described manner makes it possible to combine at least parts of the laser beams L1-1 through L1-n outputted from the respective semiconductor lasers 11-1 through 11-n with a compact optical element (beam-combining grating 12A) with ease. As a result, the master oscillator system can be reduced in size. It should be noted that although a reflective diffraction grating (beam-combining grating 12A) is used as the beam combiner 12 in the first embodiment, a transmissive diffraction grating can also be used as the beam combiner 12.

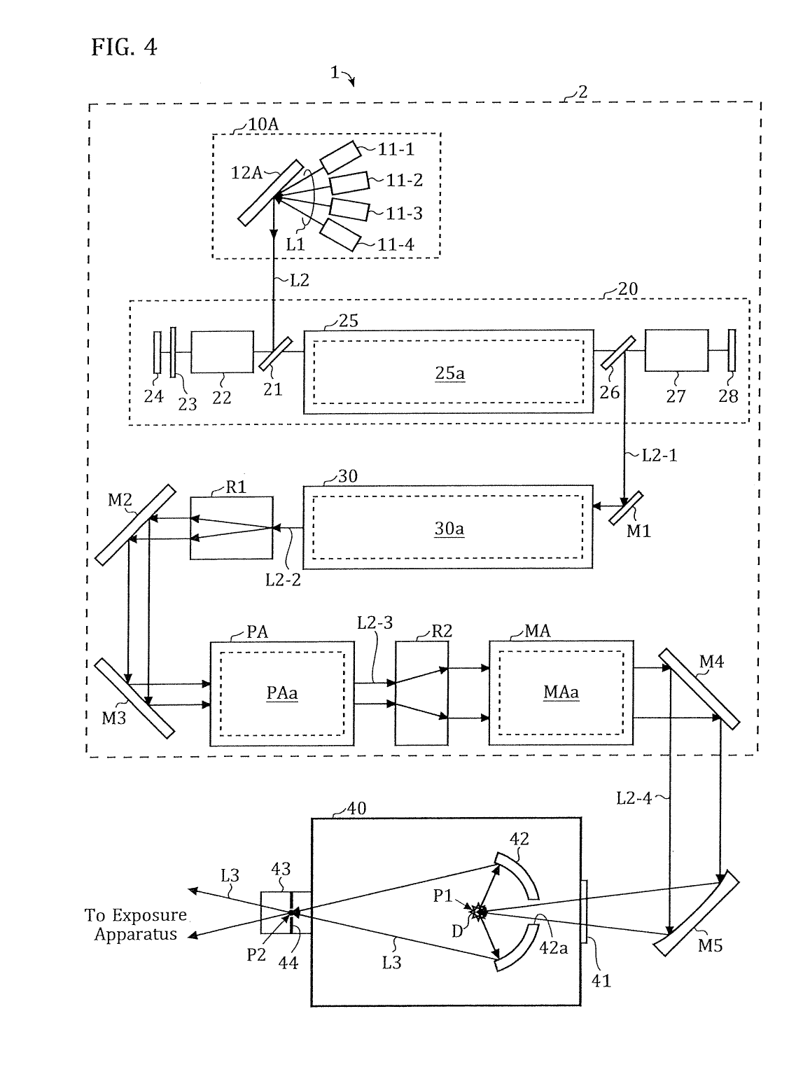

Next, an EUV light generation apparatus 1 in accordance with the first embodiment will be described in detail with reference to the drawing. FIG. 4 schematically illustrates a configuration of a driver laser and an EUV light generation apparatus in accordance with the first embodiment. As shown in FIG. 4, the EUV light generation apparatus may include a driver laser 2, an off-axis paraboloidal mirror M5, and an EUV chamber 40.

The driver laser 2 may include: the master oscillator system 10A that outputs the combined laser beam L2, in which the plurality of the laser beams L1 is combined; the regenerative amplifier 20 that amplifies the combined laser beam L2 outputted from the master oscillator system 10A and outputs the laser beam L2 as the amplified laser beam L2-1; the amplifier 30 that further amplifies the amplified laser beam L2-1 outputted from the regenerative amplifier 20; a relay optical system R1 that expands the beam diameter of an amplified laser beam L2-2 amplified in the amplifier 30 while maintaining the amplified laser beam L2-2 in a collimated state; the pre-amplifier PA that further amplifies the amplified laser beam L2-2 of which the beam diameter has been expanded; a relay optical system R2 that expands the beam diameter of an amplified laser beam L2-3 amplified in the pre-amplifier PA while maintaining the amplified laser beam L2-3 in a collimated state; the main amplifier MA that further amplifies the amplified laser beam L2-3 of which the beam diameter has been expanded; and a high-reflective mirror M4.

A laser beam L2-4 outputted from the driver laser is incident on the off-axis paraboloidal mirror M5. Then, the laser beam L2-4 reflected by the off-axis paraboloidal mirror M5 enters the EUV chamber 40 via a window 41 and is focused at a predetermined site (plasma generation site P1) inside the EUV chamber 40.

At the plasma generation site P1, a target material is irradiated with the focused laser beam L2-4, whereby plasma is generated. EUV light is emitted from this plasma.

Similarly to the configuration shown in FIG. 3, the semiconductor lasers 11-1 through 11-n (semiconductor lasers 11-1 through 11-4 in this example) shown in FIG. 4 are disposed with respect to the beam-combining grating 12A so that the pulsed laser beams L1 outputted from the semiconductor lasers 11-1 through 11-n are diffracted in the same direction and with the same diffraction angle β. The plurality of the laser beams L1 diffracted by the beam-combining grating 12A enters the regenerative amplifier 20 as the pulsed combined laser beam L2.

The regenerative amplifier 20 is configured such that a quarter-wave plate 23, an EO Pockels cell 22, a polarization beam splitter 21, a laser amplification unit 25, a polarization beam splitter 26, and an EO Pockels cell 27 are disposed between a pair of resonator mirrors 24 and 28 in this order from the side of the resonator mirror 24. The pulsed combined laser beam L2 outputted from the master oscillator system 10A is first incident on the polarization beam splitter 21. The polarization beam splitter 21 reflects with high reflectivity only a predetermined polarization component (a polarization component in a direction perpendicular to the paper surface is said to be an s-polarization component in this example) of the combined laser beam L2 incident thereon. With this, only the s-polarization component of the pulsed combined laser beam L2 is introduced into the resonator formed by the resonator mirrors 24 and 28 of the regenerative amplifier 20.

Here, the semiconductor lasers 11-1 through 11-4, for example, oscillates laser beams that are linearly polarized in a direction which coincides with the direction of the s-polarization component with respect to the polarization beam splitter 21, and the pulsed combined laser beam L2 is made to be incident on the polarization beam splitter 21 as the s-polarization component by the beam-combining grating 12A. With this, the combined laser beam L2 outputted from the master oscillator system 10A may be introduced into the regenerative amplifier 20 efficiently.

The pulsed combined laser beam L2 introduced into the resonator of the regenerative amplifier 20 passes through the EO Pockels cell 22, to which voltage is not applied, without a phase shift, and thereafter passes through the quarter-wave plate 23 to thereby be converted into a circularly polarized laser beam. The circularly polarized pulsed combined laser beam L2 is reflected with high reflectivity by the resonator mirror 24, and again passes through the quarter-wave plate 23 to thereby be converted to a pulsed laser beam that is incident on the polarization beam splitter 21 as the p-polarization component. Then, the pulsed combined laser beam L2 passes through the EO Pockels cell 22, to which voltage is not applied, and through the polarization beam splitter 21 without a phase shift, and thereafter passes through a CO₂ gas gain medium 25a inside the laser amplification unit 25, where the pulsed combined laser beam L2 is amplified. Note that the CO₂ gas gain medium 25a is excited at this time. The laser amplification unit 25 includes an amplification region containing the CO₂ gas gain medium 25a. The CO₂ gas gain medium 25a is a mixed gas containing CO₂ gas, and the amplification region is generated by exciting the CO₂ gas.

The pulsed combined laser beam L2 having been amplified as it passes through the laser amplification unit passes through the polarization beam splitter 26 and the EO Pockels cell 27, to which voltage is not applied, without a phase shift, and thereafter is reflected with high reflectivity by the resonator mirror 28. The combined laser beam L2 reflected with high reflectivity by the resonator mirror 28 again passes through the EO Pockels cell 27, to which voltage is not applied, without a phase shift. Then, the pulsed combined laser beam L2 passes through the polarization beam splitter 26, and thereafter is further amplified as it passes through the CO₂ gas gain medium 25a inside the laser amplification unit 25. The amplified pulsed combined laser beam L2 passes through the polarization beam splitter 21, and thereafter passes through the EO Pockels cell 22, to which voltage is applied, with a quarter-wavelength phase shift to thereby be converted into a circularly polarized laser beam. The EO Pockels cells 22 and 27, to which voltage is applied, give the pulsed combined laser beam L2 passing therethrough a quarter-wavelength phase shift.

The circularly polarized pulsed combined laser beam L2 outputted from the EO Pockels cell 22, to which voltage is applied, passes through the quarter-wave plate 23 to thereby be converted into a laser beam that is incident on the polarization beam splitter 21 as the s-polarization component, and thereafter is reflected with high reflectivity by the resonator mirror 24. The pulsed combined laser beam L2 that has been reflected with high reflectivity by the resonator mirror 24 again passes through the quarter-wave plate 23, to thereby be converted into a circularly polarized laser beam, and thereafter passes through the EO Pockels cell 22, to which voltage is applied, with a quarter-wavelength phase shift, to thereby be converted into a laser beam that is incident on the polarization beam splitter 21 as the p-polarization component. The pulsed combined laser beam L2 is amplified as it passes through the CO₂ gas gain medium 25a inside the laser amplification unit 25, and thereafter passes through the polarization beam splitter 26. When voltage is applied to the EO Pockels cell 22 and voltage is not applied to the EO Pockels cell 27, the pulsed combined laser beam L2 can be allowed to travel back and forth between the resonator mirrors 24 and 28. When the pulsed combined laser beam L2 is to be outputted from the regenerative amplifier 20, voltage is applied to the EO Pockels cell 27. At this time, the pulsed combined laser beam L2, which is incident on the polarization beam splitter 26 as the p-polarization component, passes through the EO Pockels cell 27, to which voltage is applied, with a quarter-wavelength phase shift, to thereby be converted into a circularly polarized laser beam, and thereafter is reflected with high reflectivity by the resonator mirror 28. The circularly polarized pulsed combined laser beam L2 that has been reflected with high reflectivity by the resonator mirror 28 again passes through the EO Pockels cell 27, to which voltage is applied, with a quarter-wavelength phase shift, to thereby be converted into a laser beam, which is incident on the polarization beam splitter 26 as the s-polarization component. Then, the pulsed combined laser beam L2 incident on the polarization beam splitter 26 as the s-polarization component is selectively reflected with high reflectivity by the polarization beam splitter 26. With this, the pulsed combined laser beam L2 having been outputted from the master oscillator system 10A is amplified in the regenerative amplifier 20 and is outputted as the pulsed amplified laser beam L2-1.

The pulsed amplified laser beam L2-1 outputted from the regenerative amplifier 20 in a manner described above is propagated to the amplifier 30 via a high-reflective mirror M1, for example. The amplifier 30 includes an amplification region which contains a CO₂ gas gain medium 30a. The pulsed amplified laser beam L2-1 that has entered the amplifier 30 is amplified as it passes through the amplification region inside the amplifier 30. Here, the amplifier 30 may be a multipass amplifier, in which the pulsed amplified laser beam L2-1 is further amplified as it travels back and forth multiple times in the amplification region. Then, a pulsed amplified laser beam L2-2 is outputted from the amplifier 30. The pulsed amplified laser beam L2-2 having been amplified by the amplifier 30 passes through the relay optical system R1 and is outputted with the beam diameter thereof expanded while being maintained in a collimated state. Here, the relay optical system R1 expands the pulsed amplified laser beam L2-2 in the radial direction thereof so that the pulsed amplified laser beam L2-2 fills substantially the entire amplification region of the pre-amplifier PA disposed downstream thereof. Then, the pulsed amplified laser beam L2-2, of which the beam diameter has been expanded in the radial direction thereof, is propagated to the pre-amplifier PA via high-reflective mirrors M2 and M3, for example.

The pre-amplifier PA includes an amplification region containing a CO₂ gas gain medium PAa. Further, as described above, the pulsed amplified laser beam L2-2 having passed through the relay optical system R1 has the beam diameter thereof being expanded in the radial direction thereof so that it passes through substantially the entire amplification region of the pre-amplifier PA. Accordingly, the pulsed amplified laser beam L2-2 having entered the pre-amplifier PA is efficiently amplified by the CO gas gain medium PAa inside the amplification region as it passes through the pre-amplifier PA, and thereafter is outputted as an amplified laser beam L2-3.

The pulsed amplified laser beam L2-3 outputted from the pre-amplifier PA has the beam diameter thereof expanded by the relay optical system R2 in the radial direction thereof while being maintained in a collimated state. The beam diameter that has been expanded is adjusted to a beam diameter that will fill substantially the entire amplification region of the main amplifier MA disposed downstream of the relay optical system R2. The main amplifier MA, similarly to the pre-amplifier PA, includes an amplification region containing a CO₂ gas gain medium MAa. Further, as described above, the pulsed amplified laser beam L2-3 that has passed through the relay optical system R2 has the beam diameter thereof being expanded in the radial direction so that the pulsed amplified laser beam L2-3 passes through substantially the entire amplification region of the main amplifier MA. Accordingly, the pulsed amplified laser beam L2-3 that has entered the main amplifier MA is efficiently amplified by the CO₂ gas gain medium MAa inside the amplification region as it passes through the main amplifier MA, and thereafter is outputted as a pulsed amplified laser beam L2-4.

The pulsed amplified laser beam L2-4 outputted from the main amplifier MA is propagated to the off-axis paraboloidal mirror M5 via the high-reflective mirror M4. The off-axis paraboloidal mirror M5 reflects with high reflectivity the pulsed amplified laser beam L2-4 incident thereon so that the reflected laser beam is focused at a predetermined site (plasma generation site P1) inside the EUV chamber 40. The pulsed amplified laser beam L2-4 reflected with high reflectivity by the off-axis paraboloidal mirror M5 enters the EUV chamber 40 via the window 41. Then, the pulsed amplified laser beam L2-4 passes through a through-hole 42a provided in an EUV collector mirror 42, and thereafter is focused at the plasma generation site P1 inside the EUV chamber 40.

A target material D serving as a plasma source is supplied to the plasma generation site P1 by a target material supply mechanism (not shown). Sn, for example, can be used as the target material D. However, without being limited thereto, any material that can be a source for plasma emitting EUV light of a desired wavelength can be used as the target material D. Further, liquid metals, solid metals, and the like can be used as the target material D. When the target material D is a liquid metal, the target material D is supplied to the plasma generation site P1 in the form of a droplet. Meanwhile, when the target material D is a solid metal, the target material D is supplied to the plasma generation site P1 in the form of, for example, a ribbon or a rotary disc formed of the target material D or in the form of a ribbon or a rotary disc coated with the target material D at least on the surface thereof.

At the plasma generation site P1, the target material D is irradiated with the focused pulsed amplified laser beam L2-4 in synchronized timing as the target material D arrives at the plasma generation site P1. With this, the target material D that has arrived at the plasma generation site P1 is irradiated with the pulsed amplified laser beam L2-4 to thereby be turned into plasma. The target material D that has been turned into plasma emits EUV light L3 as it is being deexcited. The EUV light L3 generated at the plasma generation site P1 is reflected with high reflectivity by the EUV collector mirror 42, which is disposed to face the output port of the EUV light L3 with the plasma generation site P1 located therebetween. The reflective surface of the EUV collector mirror 42 is curved (for example, in an ellipsoidal shape) such that the EUV light L3 emitted radially at the plasma generation site P1 can be focused at a predetermined site (intermediate focus P2) inside an interface 43 with the exposure apparatus disposed outside the EUV chamber 40. Accordingly, the EUV light L3 generated intermittently at the plasma generation site P1 is focused at the intermediate focus P2 as pulsed light. Disposed at the intermediate focus P2 is a partition wall 44 having an aperture through which the EUV light L3, for example, is propagated into the exposure apparatus (not shown). The EUV light L3 focused at the intermediate focus P2 is propagated into the exposure apparatus via aperture in the partition wall 44 and is used for exposure in the exposure apparatus.

In this way, in the first embodiment, the configuration is such that the plurality of the semiconductor lasers 11-1 through 11-n, of which the intensity of the laser beams to be outputted can easily be controlled, is made to oscillate respective laser beams such that at least two of the laser beams have different wavelengths, and the plurality of the semiconductor laser beams L1-1 through L1-n is combined using the beam-combining grating, which is a diffraction grating, as a beam combiner. Thus, an EUV light generation apparatus and a driver laser including a master oscillator system, serving as a laser device, of which the intensity and the pulse width of a laser beam to be outputted can easily be controlled and which is also reduced in size, can be obtained.

### Second Embodiment

Next, a master oscillator system in accordance with a second embodiment of this disclosure will be described in detail with reference to the drawings. Note that an EUV light generation apparatus and a driver laser including the master oscillator system in accordance with the second embodiment are configured similarly to the EUV light generation apparatus and the driver laser in accordance with the first embodiment.

As in the first embodiment described above, when a mixed gas containing CO₂ gas is used as a gain medium in an amplification stage, a difference Δλ in central wavelengths of adjacent gain bandwidths in a band where a transition is, for example, 00°1 to 10°0 is approximately 0.019 μm to 0.023 μm. Accordingly, when the number N of slits per unit length on a diffraction grating (beam-combining grating 12A) used as the beam combiner 12 is 40 per millimeter and the output angle (diffraction angle) β of the combined laser beam L2 is 20°, a difference Δα in incident angles α between two of the laser beams L1 corresponding to the adjacent gain bandwidths is 0.04° to 0.08°, which is significantly small. When the difference Δα is this small, unless the distance between the beam combiner 12 and the semiconductor lasers 11-1 through 11-n is sufficiently long, the adjacent semiconductor lasers 11-1 through 11-n cannot be arranged on the same plane with the semiconductor lasers 11-1 through 11-n being spaced apart from one another. This, in turn, may increase the master oscillator system in size.

Therefore, in this embodiment, not only the plus/minus first order diffraction beams but zeroth and plus/minus second order diffraction beams and beyond are used to generate a combined laser beam of the laser beams L1 outputted from the plurality of the semiconductor lasers 11-1 through 11-n. Hereinafter, the principle will be described with reference to the drawings. It should be noted that, in the description to follow, a case where a transmissive diffraction grating is used as a beam-combining grating 12B in accordance with the second embodiment will be shown as an example.

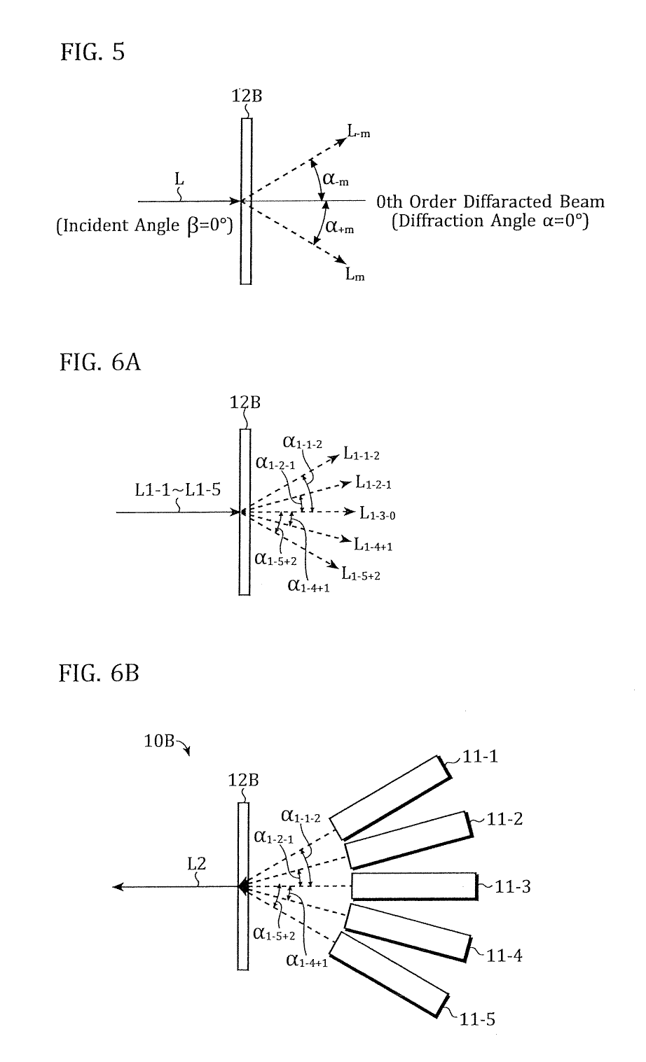

FIG. 5 schematically illustrates plus/minus m-th order diffraction beams of a beam incident on a beam-combining grating with an incident angle β=0° in accordance with the second embodiment. As shown in FIG. 5, the transmissive beam-combining grating 12B diffracts, based on the wavelength selectivity (dispersion) thereof, plus/minus m-th order diffraction beams L_{±m} of a beam L that is incident thereon with an angle β=0° with diffraction angles α₊ₘ and α₋ₘ dependent on a wavelength λ of the incident beam L. At this time, the relationship between the diffraction angles α₊ₘ and the wavelength λ satisfies the formula 3 shown later. Note that, in the formula 3, m represents the order of a diffraction beam to be combined, and N represents the number of slits per unit length (per millimeter) on a diffraction grating. In the formula 3, however, since an incident angle β is 0°, a term pertaining to β is omitted.

Further, the formula 3 is satisfied even when the incident angle β and the diffraction angle α are interchanged. In other words, when a laser beam is incident on the transmissive beam-combining grating 12B with an incident angle α_{±m}, all the diffraction beams to be combined are transmitted and diffracted with a diffraction angle β=0°.

Nmλ=sin α (Formula 3)

Thus, in the second embodiment, the laser beams L1-1 through L1-5 outputted from the respective semiconductor lasers 11-1 through 11-5 are combined by the beam-combining grating.

FIG. 6A is a schematic diagram in which the plurality of the laser beams outputted from the respective semiconductor lasers is incident on the beam-combining grating with an incident angle 0° and each of the laser beams is diffracted at differing orders from one another. To be more specific, each of the laser beams L1-1 through L1-5 outputted from the respective semiconductor lasers 11-1 through 11-5 is incident on the transmissive beam-combining grating 12B with an incident angle β=0°, and the laser beams L1-1 through L1-5 are transmitted and diffracted. Here, the diffraction beams of differing orders are diffracted respectively in the directions of the diffraction angles α₁₋₁₋₂ through α₁₋₅₊₂.

Contrary to the arrangement shown in FIG. 6A, FIG. 6B is a schematic diagram in which the plurality of the semiconductor lasers are disposed so that the respective laser beams are incident on the beam-combining grating with the respective incident angles and the diffraction beams thereof are diffracted with the same angle 0°. To be more specific, the laser beams L1-1 through L1-5 outputted from the respective semiconductor lasers 11-1 through 11-5 are incident on the beam-combining grating 12B with incident angles α₁₋₁₋₂ through α₁₋₅₊₂, respectively. As a result, the diffraction beams of differing orders of the respective laser beams L1-1 through L1-5 outputted from the semiconductor lasers L1-1 through L1-5, respectively, are each diffracted with the diffraction angle β=0°, whereby the combined laser beam L2 is outputted.

The laser beams of differing wavelengths outputted from the semiconductor lasers 11-1 through 11-n are incident on the beam-combining grating 12B with respective incident angles α₁ through αₙ. When the diffraction beams of the same order (for example m=−1) are diffracted with the diffraction angle 0°, the diffraction angle depends solely on the difference in the wavelengths of the laser beams outputted from the semiconductor lasers. Accordingly, when a difference Δλ in the wavelengths of the laser beams outputted from the semiconductor lasers 11-1 through 11-n is as small as from 0.019 μm to 0.023 μm with respect to the wavelength of 10.6 μm (see FIG. 3), a difference Δα in incident angles is small in comparison to case of the second embodiment. Accordingly, an advantage of the second embodiment is that making the diffraction angles of the diffraction beams of differing orders coincide with each other makes it possible to increase the difference Δα in incident angles. As a result, even when the distance between the beam combiner 12 and the semiconductor lasers 11-1 through 11-n is relatively short, the adjacent semiconductor lasers 11-1 through 11-n can be arranged on the same plane with the semiconductor lasers 11-1 through 11-n being spaced apart from one another. As a result, the master oscillator system 10B can be reduced in size. FIG. 6A schematically illustrates zeroth to plus/minus second order diffraction beams of a laser beam incident on the beam-combining grating with an incident angle β=0° in accordance with the second embodiment. FIG. 6B schematically illustrates a configuration of the master oscillator system in accordance with the second embodiment.

Here, TABLE 1 below shows the relationship among the order m of a diffraction beam, a diffraction angle α, and a difference Δα in the diffraction angles of the adjacent diffraction beams, when the number N of slits in the diffraction grating per unit length is 10 per millimeter and the wavelength of the incident beam L is 10.6 μm.

TABLE 1

| | Diffraction Angle α | Difference Δα in |
|---|---|---|
| Order m | [°] | Diffraction Angles [°] |
| −3 | −18.54 | |
| | | 6.30 |
| −2 | −12.24 | |
| | | 6.15 |
| −1 | −6.08 | |
| | | 6.08 |
| 0 | 0.00 | |
| | | 6.08 |
| +1 | 6.08 | |
| | | 6.15 |
| +2 | 12.24 | |
| | | 6.30 |
| +3 | 18.54 | |

As shown in TABLE 1 above, in the second embodiment, the number N of slits on the diffraction grating per unit length is set to approximately 10 per millimeter, whereby the difference Δα in the diffraction angles between the adjacent diffraction beams can be set to approximately 6° or above. With this, the semiconductor lasers 11-1 through 11-n can be disposed sufficiently close to the beam combiner 12 (more specifically, beam-combining grating 12B). As a result, the master oscillator system 10B can reduced in size.

Further, in the second embodiment, the semiconductor lasers 11-1 through 11-n can be arranged symmetrically with respect to an axis perpendicular to the diffraction surface of the beam-combining grating 12B, which allows the semiconductor lasers 11-1 through 11-n to be arranged simply with respect to the beam-combining grating 12B.

Materials for the beam-combining grating 12B, which preferably are materials through which the laser beams L1 of a plurality of wavelengths corresponding to the plurality of the gain bandwidths of the gain medium containing CO₂ gas can be transmitted, includes zinc selenide (ZnSe) or the like. Without being limited thereto, however, any material through which a laser beam having a wavelength corresponding to a gain bandwidth of a gain medium (for example, CO₂ gas) used for an amplifier can be transmitted can be employed.

As described above, similarly to the first embodiment, in the second embodiment, at least two of the plurality of the semiconductor lasers 11-1 through 11-n, of which the intensity of a laser beam to be outputted therefrom can easily be controlled, oscillate laser beams of differing wavelengths. Further, the configuration is such that the plurality of the laser beams L1-1 through L1-n are combined using the beam-combining grating, which is a diffraction grating, as the beam combiner. Thus, a driver laser, of which the intensity of a laser beam to be outputted therefrom can easily be controlled, can be obtained.

### Modification

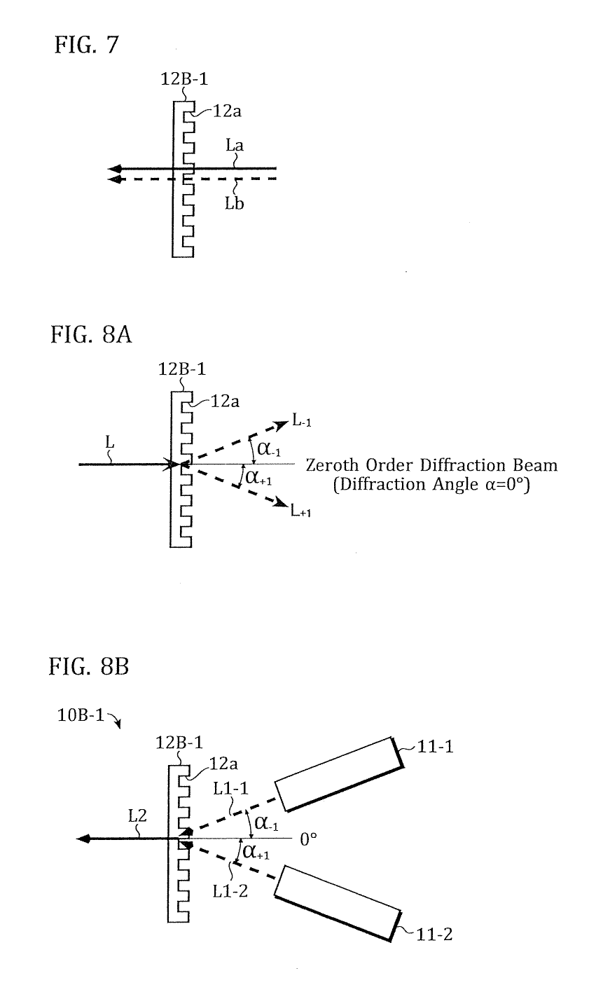

Further, similarly to the second embodiment described above, when a transmissive diffraction grating is used as the beam combiner 12, regulating the shape of a groove formed on the diffraction surface makes it possible to achieve the beam combiner 12 with high beam-combining efficiency. As a specific example, FIG. 7 shows a case where a beam-combining grating 12B-1, which is a transmissive diffraction grating having a plurality of rectangular shaped grooves 12a formed thereon, is used as the beam combiner 12. The depth of the groove 12a is set such that a laser beam La having passed through the mesa-shaped section and a laser beam Lb having passed through the groove 12a have the phase difference of π. With this, desired plus m-th order diffraction beam and minus m-th order diffraction beam can be made to appear strongly. As a result, the beam combiner 12 with high beam-combining efficiency can be achieved. Here, the beam-combining efficiency is a ratio of the intensity of a combined semiconductor laser beam with respect to the intensity of a laser beam outputted from a semiconductor laser.

FIG. 7 is a sectional view of a transmissive diffraction grating with which a laser beam having passed the mesa-shaped section and a laser beam having passed the groove section have the phase difference of π.

FIG. 8A schematically illustrates plus/minus first order diffraction beams L±₁ of the incident beam L diffracted with the diffraction angles a_{±1}. Meanwhile, FIG. 8B schematically illustrates a master oscillator system 10B-1, in which the laser beams are incident on a beam-combining grating 12B-1 with incident angles of a_{±1} and the laser beams are diffracted with the diffraction angle β=0° by the beam-combining grating 12B-1. To be more specific, the semiconductor laser 11-1 that outputs the laser beam L1-1 is disposed such that the laser beam L1-1 is incident on the beam-combining grating 12B-1 with an incident angle of a₋₁, and the semiconductor laser 11-2 that outputs the laser beam L1-2 is disposed such that the laser beam L1-2 is incident on the beam-combining grating 12B-1 with an incident angle of a₊₁. The laser beam L1-1 and L1-2 of the respective semiconductor lasers 11-1 and 11-2 are diffracted by the beam-combining grating 12B-1 with the same diffraction angle β=0° and are at least partially combined. In this case, in comparison to a regular slit-type or groove-type diffraction grating, the beam-combining grating in the second embodiment may yield higher beam-combining efficiency, whereby more intense combined laser beam L2 can be obtained.

Further, as a material for the beam-combining grating 12B-1, any material, such as zinc selenide (ZnSe) through which a laser beam of a wavelength corresponding to a gain bandwidth of a gain medium (for example, CO₂ gas) used for an amplifier can be transmitted, may be employed.

### Third Embodiment

Next, a master oscillator system in accordance with a third embodiment of this disclosure will be described in detail below. An EUV light generation apparatus and a driver laser including a multi-line master oscillator system in accordance with the third embodiment are configured similarly to the EUV light generation apparatus and the laser device in accordance with the first embodiment described above.

In the second embodiment described above, a transmissive diffraction grating (beam-combining grating 12B or 12B-1) has been used as the beam combiner 12. In the third embodiment, however, a reflective diffraction grating is used, whereby not only plus/minus first order diffraction beams but zeroth and plus/minus second order diffraction beams and beyond are used to generate a combined beam of the laser beams L1 outputted from the plurality of the semiconductor lasers 11-1 through 11-n. Hereinafter, the principle will be described with reference to the drawings.

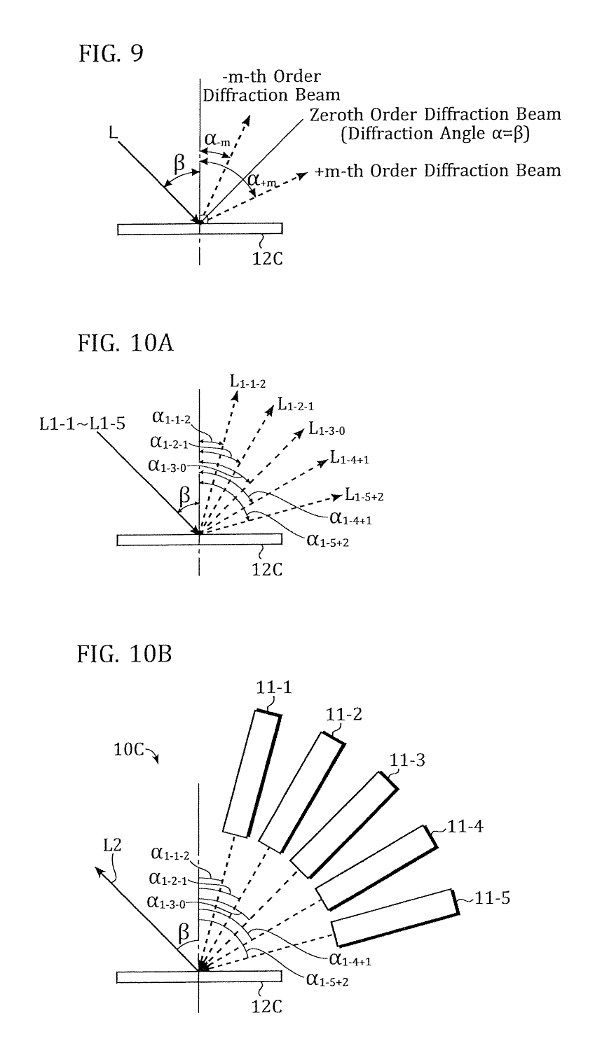

FIG. 9 schematically illustrates zeroth and plus/minus m-th order diffraction beams of a beam incident on a beam-combining grating with an incident angle β in accordance with the third embodiment. As shown in FIG. 9, similarly to the transmissive beam-combining grating 12B/12B-1, a reflective beam-combining grating 12C in accordance with the third embodiment diffracts, based on the wavelength selectivity (dispersion) thereof, plus/minus m-th order diffraction beams L_{±m} of the beam L that is incident thereon with an incident angle β with the diffraction angle ±α dependent on the wavelength λ of the incident beam L. At this time, the relationship among the incident angle β, the diffraction angle α, and the wavelength λ satisfies the formula 1 shown above. Here, zeroth order diffraction beam is reflected with an angle β=α, which is independent of the wavelength.

FIG. 10A illustrates diffraction angles α₁₋₁₋₂ through α₁₋₅₊₂ of the diffraction beams that appear when the laser beams L1-1 through L1-5 outputted from the respective semiconductor lasers 11-1 through 11-5 are incident on the beam-combining grating 12C with an incident angle β.

FIG. 10B, on the other hand, schematically illustrates a master oscillator system 10C, in which the semiconductor lasers 11-1 through 11-5 are disposed such that the laser beam L1-1 through L-5 are incident on the beam-combining grating 12C with incident angles α₁₋₁₋₂ through α₁₋₅₊₂, and zeroth, plus/minus first, and plus/minus second order diffraction beams of the laser beams L1-1 through L1-5 have the same diffraction angle β. The laser beams L1-1 through L1-5 are incident on the beam-combining grating 12C with the respective incident angles α₁₋₁₋₂ through α₁₋₅₊₂. Then, the beam-combining grating 12C diffracts zeroth, plus/minus first, and plus/minus second order diffraction beams with the same diffraction angle β. That is, the beam-combining grating 12C combines the plurality of the laser beams.

In comparison to the case described in the first embodiment, this method advantageously makes it possible to increase the difference Δα in incident angles of the adjacent laser beams L1-1 through L1-n. In the first embodiment, the laser beams L1-1 through L1-n are incident on the beam-combining grating with the respective incident angles α₋₁, and are diffracted with the same diffraction angle β, under the condition of the same diffraction order (for example, m=−1) (see, FIG. 3). In this case, the difference Δα in incident angles of the adjacent laser beams L1-1 through L1-n is small.

In the third embodiment, similarly to the second embodiment described above, even when the distance between the beam combiner 12 and the semiconductor lasers 11-1 through 11-n is relatively small, the adjacent semiconductor lasers 11-1 through 11-n can be disposed on the same plane with the semiconductor lasers 11-1 through 11-n being space apart from one another. As a result, the master oscillator system 10C can be reduced in size.

TABLE 2 below shows the relationship among the order m of the diffraction beams, the diffraction angles α, and the differences Δα in the diffraction angles of the adjacent diffraction beams, when the number N of slits on the diffraction grating per unit length is set to 10 per millimeter, an incident angle β of the incident beam L is 20°, and the wavelength of the incident beam L is 10.6 μm.

TABLE 2

| | Diffraction Angle α | Difference Δα in |
|---|---|---|
| Order m | [°] | Diffraction Angles [°] |
| −3 | 41.30 | |
| | | 7.66 |
| −2 | 33.64 | |
| | | 7.03 |
| −1 | 26.62 | |
| | | 6.62 |
| 0 | 20.00 | |
| | | 6.35 |
| +1 | 13.65 | |
| | | 6.18 |
| +2 | 7.47 | |
| | | 6.09 |
| +3 | 1.38 | |

As shown in TABLE 2 above, in the third embodiment, the number N of slits on the diffraction grating per unit length is set to approximately 10 per millimeter, whereby the differences Δα in the diffraction angles of the adjacent diffraction beams can be set to approximately 6° or above. This makes it possible to dispose the semiconductor lasers 11-1 through 11-n sufficiently close to the beam combiner 12 (more specifically, the beam-combining grating 12C). As a result, the master oscillator system 10C can be reduced in size.

Further, in the third embodiment, a reflective diffraction grating is used for the beam combiner 12; thus, the semiconductor lasers 11-1 through 11-n are disposed to the side of the beam combiner 12 to which the combined laser beam L2 is outputted. With this, the semiconductor lasers 11-1 through 11-n can be disposed close to an incident window of a unit to which the combined laser beam L2 is inputted (regenerative amplifier 20 in this embodiment). As a result, the driver laser 2 including the master oscillator system 10C can be designed more compactly. Further, the EUV light generation apparatus 1 including the driver laser 2 can be reduced in size.

As has been described so far, in the third embodiment, similarly to the embodiments described above (including the modifications thereof), the semiconductor lasers 11-1 through 11-n, of which the intensity of a laser beam to be outputted therefrom can easily be controlled, outputs the laser beams of at least one wavelength. The laser beams L1-1 through L1-n are combined by the beam-combining grating. The beam-combining grating is configured of a diffraction grating and functions as a beam combiner. Accordingly, a driver laser, of which the intensity of a laser beam to be outputted therefrom can easily be controlled, can be achieved.

### Modification

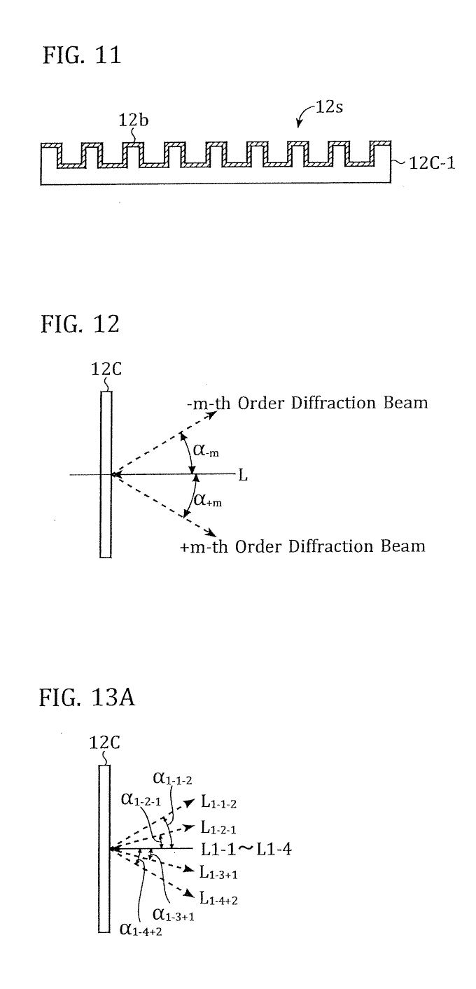

Further, as in the third embodiment described above, when a reflective diffraction grating is used for the beam combiner 12, as in the beam-combining grating 12C-1 shown in FIG. 11, a diffraction surface 12s of the beam-combining grating 12C may be coated with a high-reflective film 12b of a metal or the like which has high reflectivity to a beam of a wavelength to be used. As a material for the high-reflective film 12b, for example, gold (Au), aluminum (Al), or the like, or an alloy thereof may be used. Further, the high-reflective film 12b may be a multi-layered film of the above-mentioned metals or an alloy thereof, or a multi-layered film of a dielectric of different materials. FIG. 11 is a sectional view of a beam-combining grating in accordance with the modification of the third embodiment, taken along a plane perpendicular to a direction in which the grooves are formed on the diffraction surface of the beam-combining grating.

### Fourth Embodiment

Next, a master oscillator system in accordance with a fourth embodiment of this disclosure will be described in detail below. An EUV light generation apparatus and a driver laser including the master oscillator system in accordance with the fourth embodiment are configured similarly to the EUV light generation apparatus and the driver laser in accordance with the first embodiment.

In the third embodiment described above, the semiconductor lasers 11-1 through 11-n are disposed with respect to the beam-combining grating 12C or 12C-1 such that the combined laser beam L2 is outputted in a direction inclined with respect to the diffraction surface of the reflective diffraction grating (beam-combining grating 12C or 12C-1). Meanwhile, in the fourth embodiment, the plurality of the semiconductor lasers 11-1 through 11-n are disposed with respect to the diffraction grating such that the combined laser beam L2 is outputted in a direction perpendicular to the diffraction surface of the diffraction grating. With this, in the fourth embodiment, not only plus/minus first order diffraction beams but plus/minus second order diffraction beams and beyond can be used to combine the laser beams L1 outputted from the plurality of the semiconductor lasers 11-1 through 11-n. Hereinafter, the principle will be described with reference to the drawings.

FIG. 12 schematically illustrates plus/minus m-th order diffraction beams of a beam incident on a beam-combining grating with an incident angle 0° in accordance with the fourth embodiment. As shown in FIG. 12, in the fourth embodiment, the reflective beam-combining grating 12C of the above-described third embodiment will be used for the beam combiner 12. This reflective beam-combining grating 12C diffracts plus/minus m-th order diffraction beams L_{±m} of a beam L that is incident thereon with an incident angle β=0° with an angle α_{±m} dependent on the wavelength λ of the incident beam L. At this time, the relationship between the angle α_{±m} and the wavelength λ satisfies the above-mentioned formula 3.

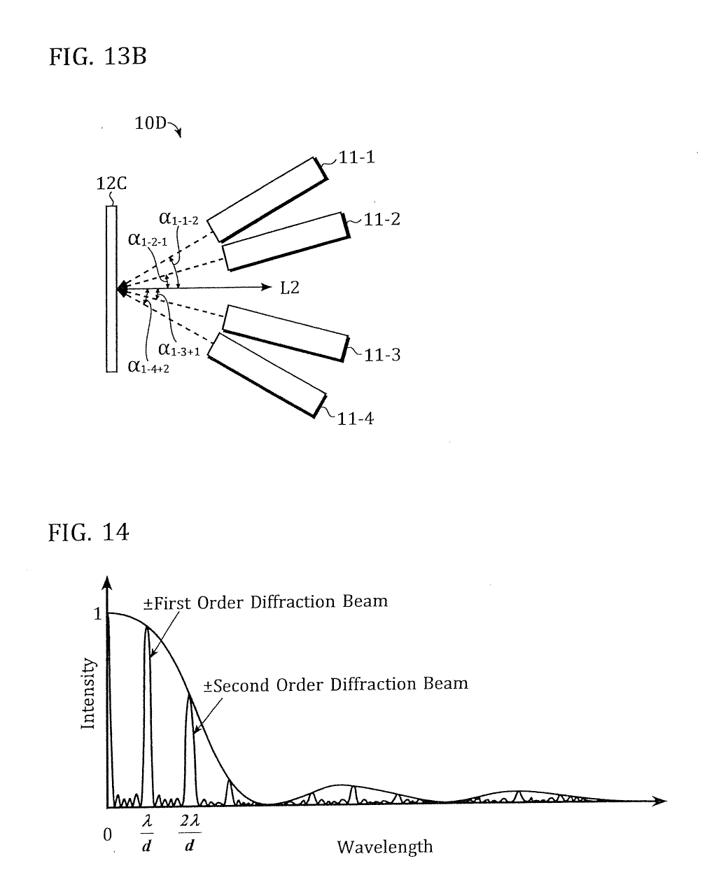

FIG. 13A schematically illustrates diffraction angles α₁₋₁₋₂ through α₁₋₄₊₂ of the diffraction beams of differing orders, which appear when the laser beams L1-1 through L1-4 outputted from the respective semiconductor lasers 11-1 through 11-4 are incident on the beam-combining grating 12C with an incident angle β=0°.

FIG. 13B, on the other hand, schematically illustrates a master oscillator system, in which the semiconductor lasers 11-1 through 11-4 are disposed such that the respective laser beams are incident on the beam-combining grating 12C with incident angles α₁₋₁₋₂ through α1−4+2, and plus/minus first and second order diffraction beams of the laser beams have the same diffraction angle β=0°. Plus/minus first and second order diffraction beams of the laser beams L1-1 through L1-4 are diffracted with the same diffraction angle β=0°. That is, the laser beams are combined by the beam-combining grating 12C.

In comparison to the first embodiment described above, this method advantageously makes it possible to increase the difference Δα in incident angles of the adjacent laser beams L1-1 through L1-4. In the first embodiment, the laser beams L1-1 through L1-n are incident on the beam-combining grating with the respective incident angles α₋₁ and are diffracted with the same diffraction angle β, under the condition of the same diffraction order (for example, m=−1) (see, FIG. 3). In this case, the difference Δα in incident angles of the adjacent laser beams L1-1 through L1-n is small. In the fourth embodiment, even when the distance between the beam combiner 12 and the semiconductor lasers 11-1 through 11-n is relatively small, the adjacent semiconductor lasers 11-1 through 11-n can be disposed on the same plane with the semiconductor lasers 11-1 through 11-n being spaced apart from one another. As a result, the master oscillator system 10D can be reduced in size.

TABLE 3 below shows the relationship among the order m of the diffraction beams, the diffraction angles α, and the differences Δα in the diffraction angles of the adjacent diffraction beams, when the number N of slits on the diffraction grating per unit length is set to 10 per millimeter and the wavelength of the incident beam L is 10.6 μm.

TABLE 3

| | Diffraction Angle α | Difference Δα in |
|---|---|---|
| Order m | [°] | Diffraction Angles [°] |
| −3 | 18.54 | |
| | | 6.30 |
| −2 | 12.24 | |
| | | 6.15 |
| −1 | 6.08 | |
| | | 6.08 |
| 0 | 0.00 | |
| | | 6.08 |
| +1 | −6.08 | |
| | | 6.15 |
| +2 | −12.24 | |
| | | 6.30 |
| +3 | −18.54 | |

As shown in TABLE 3 above, in the fourth embodiment, the number N of slits on the diffraction grating per unit length is set to approximately 10 per millimeter, whereby the differences Δα in the diffraction angles of the adjacent diffraction beams can be set to approximately 6° or above. This makes it possible to dispose the semiconductor lasers 11-1 through 11-n sufficiently close to the beam combiner 12 (more specifically, the beam-combining grating 12C). As a result, the master oscillator system 10D can be reduced in size.

Further, in the fourth embodiment, similarly to the second embodiment described above, the semiconductor lasers 11-1 through 11-n may be disposed symmetrically with respect to an axis perpendicular to the diffraction surface of the beam-combining grating 12C, which allows the semiconductor lasers 11-1 through 11-n to be arranged simply with respect to the beam-combining grating 12C.

Further, in the fourth embodiment, a reflective diffraction grating is used for the beam combiner 12; thus, the semiconductor lasers 11-1 through 11-n are disposed to a side of the beam combiner 12 into which the combined laser beam L2 is outputted. With this, similarly to the third embodiment described above, the semiconductor lasers 11-1 through 11-n can be disposed such that an incident window of a unit to which the combined laser beam L2 is inputted (regenerative amplifier 20 in this embodiment) is located between the semiconductor lasers 11-1 through 11-n. As a result, the driver laser 2 including the multi-line master oscillator system 10D can be designed more compactly.

Here, FIG. 14 shows a beam intensity spectrum when a laser beam is diffracted by a reflective diffraction grating. Note that FIG. 14 shows a case where a regular reflective diffraction grating in which the blaze angle or the slit depth is adjusted is used. As shown in FIG. 14, when the reflective diffraction grating is used, if the intensity of zeroth order diffraction beam is 1, the intensity of plus/minus first order diffraction beams is approximately at or above 0.9 and the intensity of plus/minus second order diffraction beams is approximately at or above 0.5. This reveals that the use efficiency of 10% to 20% of the laser beam incident on the reflective diffraction grating can be achieved. The fourth embodiment is advantageous in that high use efficiency can be achieved with uncomplicated grating (regular grating without the groove depth being controlled and only with reflective slits being formed).

As has been described so far, in the fourth embodiment, similarly to the embodiments (including the modifications thereof) described above, the semiconductor lasers 11-1 through 11-n, of which the intensity of a laser beam to be outputted therefrom can easily be controlled, outputs laser beams of at least one wavelength. The laser beams L1-1 through L1-n are combined by the beam-combining grating. The beam-combining grating is configured of a diffraction grating and functions as a beam combiner. Accordingly, a driver laser, of which the intensity of a laser beam to be outputted therefrom can easily be controlled, can be achieved.

### Fifth Embodiment

Next, a master oscillator system in accordance with a fifth embodiment of this disclosure will be described in detail below. An EUV light generation apparatus and a driver laser including the master oscillator system in accordance with the fifth embodiment are configured similarly to the EUV light generation apparatus and the driver laser in accordance with the first embodiment described above.

In the second embodiment described above, a case where the laser beams outputted from the semiconductor lasers 11-1 through 11-n are incident directly on the transmissive diffraction grating (the beam-combining grating 12B, 12B-1) has been shown as an example. That is, the semiconductor lasers need to be arranged radially so that the laser beams L1-1 through L1-n outputted from the respective semiconductor lasers L1-1 through L1-n are incident directly on the transmissive beam-combining grating 12B or 12B-1. On the other hand, in the fifth embodiment, a lens for controlling beam axes of the laser beams L1-1 through L1-n is intervened between the semiconductor lasers that output the laser beams and the beam-combining grating. With this, in the fifth embodiment, the semiconductor lasers 11-1 through 11-n can be arranged more freely, and as a result, the master oscillator system can be reduced in size.

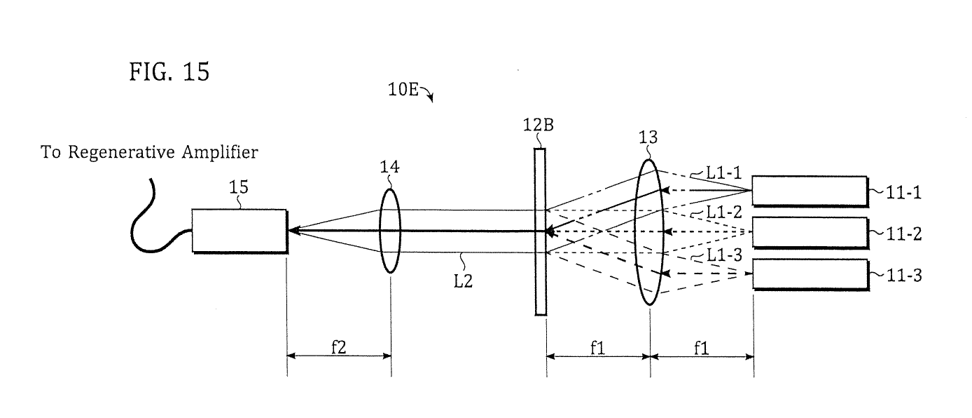

FIG. 15 schematically illustrates a configuration of the master oscillator system in accordance with the fifth embodiment. As shown in FIG. 15, a master oscillator system 10E in accordance with the fifth embodiment is configured such that a collimator lens 13 for controlling beam axes of the laser beams L1-1 through L1-3 is intervened between the beam-combining grating 12B, which is a transmissive diffraction grating, and the semiconductor lasers 11-1 through 11-3 that output the laser beams L1-1 through L1-3, respectively. The beam-combining grating 12B may be identical to the beam-combining grating 12B in accordance with the second embodiment described above.

The semiconductor lasers 11-1 through 11-3 are aligned on a plane parallel with the diffraction surface of the beam-combining grating 12B so that the directions in which the laser beams L1-1 through L1-3 are outputted are parallel with one another. The collimator lens 13 collimates each of the laser beams L1-1 through L1-3 outputted from the semiconductor lasers 11-1 through 11-3 with divergence. Then, the collimator lens 13 makes the collimated laser beams L1-1 through L1-3 incident on the same region in the diffraction surface of the beam-combining grating 12B.

Here, the focal distance of the collimator lens 13 being f1, the beam-combining grating 12B and the semiconductor lasers 11-1 through 11-3 are disposed so as to oppose each other with a distance twice the focal distance f1 therebetween. Accordingly, the collimator lens 13 is disposed at an intermediate position between the beam-combining grating 12B and the semiconductor lasers 11-1 through 11-3 for example; that is, the collimator lens 13 is disposed at a position which is equidistanced from the beam-combining grating 12B and the semiconductor lasers 11-1 through 11-3 by the focal distance f1.

With the above-described configuration, beam spots of the laser beams L1-1 through L1-3 formed on the diffraction surface of the beam-combining grating 12B can be made to substantially coincide with one another.

Further, the positions of the semiconductor lasers 11-1 through 11-3 are adjusted in a direction parallel to the optical axis of the collimator lens 13 so that the beam axes of the laser beams L1-1 through L1-3, of which the beam axes have been modified by the collimator lens 13, satisfy the above-mentioned formula 3 with respect to the beam-combining grating 12B. For example, the position of the semiconductor laser 11-1, of which minus first order diffraction beam is used for the combined laser beam L2, is adjusted in a direction parallel to the optical axis of the collimator lens 13 so that the beam axis of the laser beam L1-1, of which the beam axis has been modified by the collimator lens 13, substantially coincides with the direction in which minus first order diffraction beam is outputted when the laser beam L1-1 is incident on the beam-combining grating 12B with an incident angle β=0°. Similarly, the position of the semiconductor laser 11-3, of which plus first order diffraction beam is used for the combined laser beam L2, is adjusted in a direction parallel to the optical axis of the collimator lens 13 so that the beam axis of the laser beam L1-3, of which the beam axis has been modified by the collimator lens 13, substantially coincides with the direction in which plus first order diffraction beam is outputted when the laser beam L1-3 is incident on the beam-combining grating 12B with an incident angle β=0°. Note that, in the fifth embodiment, zeroth order diffraction beam of the laser beam L1-2 is used for the combined laser beam L2; thus, the semiconductor laser 11-2 is disposed such that the output axis of the laser beam L1-2 substantially coincides with the optical axis of the collimator lens 13.

The laser beams L1-1 through L1-3 are each collimated by the collimator lens 13. Then, the collimated laser beams are incident on the same region in the diffraction surface of the beam-combining grating 12B with their respective incident angles and are transmitted and diffracted with the same diffraction angle 0°. As a result, the laser beams L1-1 through L1-3 are collimated and outputted as the combined laser beam L2 by the collimator lens 13 and the beam-combining grating 12B.

Accordingly, the combined laser beam L2 in accordance with the fifth embodiment is a collimated beam having a predetermined beam diameter. The combined laser beam L2 having the predetermined beam diameter passes through a focusing lens 14 disposed downstream of the beam-combining grating 12B, to thereby be focused at a position that is distanced by a focal distance f2 of the focusing lens 14.

Disposed at the focal position of the focusing lens 14 is an input end of an optical fiber 15 that introduces the laser beam into the regenerative amplifier 20 (see FIG. 4). Accordingly, the combined laser beam L2 focused at the focal position of the focusing lens 14 is propagated to the regenerative amplifier 20 via the optical fiber 15.

As has been described so far, in the fifth embodiment, similarly to the embodiments (including the modifications thereof) described above, the configuration is such that the laser beams L1-1 through L1-n of at least one wavelength outputted from the respective semiconductor lasers 11-1 through 11-n, of which the intensity of a laser beam to be outputted therefrom can easily be controlled, are combined using the beam-combining grating, which is a diffraction grating, as the beam combiner. Accordingly, a driver laser including a master oscillator system, of which the intensity of a laser beam to be outputted therefrom can easily be controlled and which is reduced in size, can be achieved.

Further, in accordance with the fifth embodiment, even when the divergence angles of the laser beams L1-1 through L1-n outputted from the respective semiconductor lasers 11-1 through 11-n are relatively large, the laser beams L1-1 through L1-n can be focused and introduced into the regenerative amplifier 20 as the combined laser beam L2. This makes it possible to increase the intensity of the combined laser beam L2 to be inputted into the regenerative amplifier 20. As a result, the gain efficiency in the regenerative amplifier 20 is increased, and the following effects can be obtained, for example. First, the intensity of the laser beam inputted into the regenerative amplifier is high, whereby it is possible to amplify the inputted laser beam while substantially maintaining the pulse shape thereof. Second, the intensity of the laser beam inputted into the regenerative amplifier is high, whereby parasitic oscillation or self-oscillation can be suppressed. Third, the intensity and the pulse shape of a laser beam amplified in the regenerative amplifier can further be amplified efficiently by an amplifier disposed downstream of the regenerative amplifier. As a result, energy-saving in the regenerative amplifier 20, the amplifier 30, the pre-amplifier PA, the main amplifier MA, and the like can be achieved. Fourth, focusing performance of the pulsed amplified laser beam L2-4 with which the target material D is irradiated inside the EUV chamber 40 (see FIG. 4) is maintained, whereby the EUV light L3 with high intensity can be obtained stably.

Further, according to the fifth embodiment, the semiconductor lasers 11-1 through 11-n are disposed such that the beam axes thereof are parallel with one another, and each of the outputted laser beams is collimated, which can be combined. Accordingly, the arrangement of the collimator lens 13 and the semiconductor lasers 11-1 through 11-n with respect to the beam-combining grating 12B can be designed as desired with relative ease.

### Sixth Embodiment

Next, a master oscillator system in accordance with a sixth embodiment of this disclosure will be described in detail below. An EUV light generation apparatus and a driver laser including the master oscillator system in accordance with this embodiment are configured similarly to the EUV light generation apparatus and the driver laser in accordance with the first embodiment described above.

In the third embodiment described above, a case where the laser beams outputted from the semiconductor lasers 11-1 through 11-n are incident directly on the reflective diffraction grating (the beam-combining grating 12C, 12C-1) has been shown as an example. That is, the semiconductor lasers need to be arranged radially so that the laser beams L1-1 through L1-n outputted from the respective semiconductor lasers L1-1 through L1-n are incident directly on the reflective beam-combining grating 12C or 12C-1. On the other hand, in the sixth embodiment, a concave mirror is disposed on the beam route of the laser beams outputted from the semiconductor lasers such that the laser beams reflected thereby are incident on the beam-combining grating, and another concave mirror is intervened on the beam route from the beam-combining grating for controlling the beam axes of the laser beams L1-1 through L1-n.

With this, in the sixth embodiment, the semiconductor lasers 11-1 through 11-n can be arranged more freely, and as a result, the master oscillator system can be reduced in size.

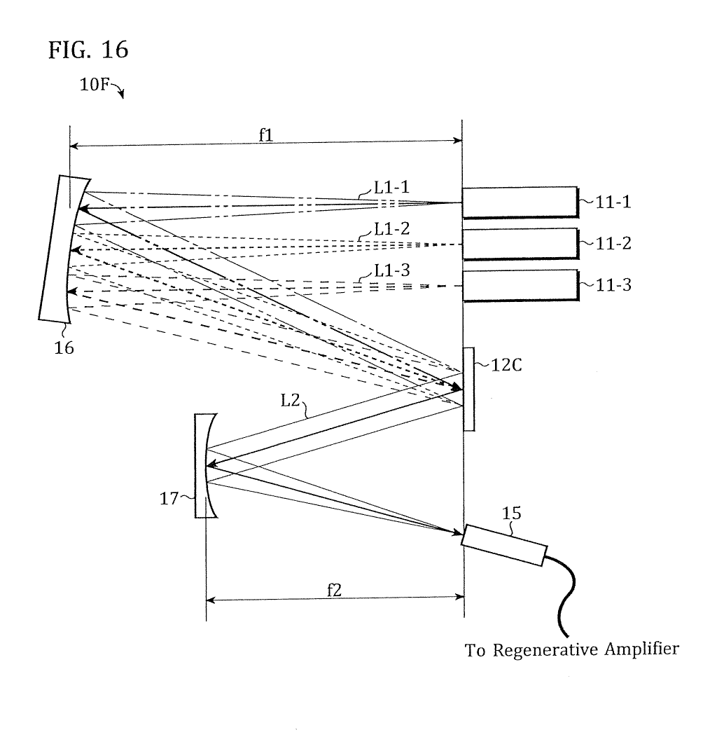

FIG. 16 schematically illustrates a configuration of the master oscillator system in accordance with the sixth embodiment. As shown in FIG. 16, a master oscillator system 10F in accordance with the sixth embodiment is configured such that a concave mirror 16 is disposed on the beam route of the laser beams L1-1 through L1-3 outputted from the respective semiconductor lasers 11-1 through 11-3 for reflecting the laser beams L1-1 through 11-3 and controlling the beam axes of the reflected laser beams L1-1 through L1-3. Note that the beam-combining grating 12C may be identical to the beam-combining grating 12C in accordance with the third embodiment described above.

The semiconductor lasers 11-1 through 11-3 are aligned on the same plane so that the directions of the laser beams L1-1 through L1-3 outputted therefrom are parallel with one another. The concave mirror 16 collimates each of the laser beams L1-1 through L1-3 outputted from the respective semiconductor lasers 11-1 through 11-3 with divergence. Then, the collimated laser beams are incident on the same region in the diffraction surface of the beam-combining grating 12C with their respective incident angles, and are reflected and diffracted with the same diffraction angle. As a result, the collimated laser beams L1-1 through L1-3 are outputted as the combined laser beam L2 by the beam-combining grating.

Here, the focal distance of the concave mirror 16 being f1, the concave mirror 16 and the semiconductor lasers 11-1 through 11-3, and the concave mirror 16 and the beam-combining grating 12C are disposed to oppose each other with the focal distance f1 therebetween. Such configuration enables the beam spots of the laser beams L1-1 through L1-3 formed on the diffraction surface of the beam-combining grating 12C to substantially coincide with one another.

Further, the positions of the semiconductor lasers 11-1 through 11-3 are adjusted such that the beam axes of the laser beams L1-1 through L1-3 reflected with high reflectivity by the concave mirror 16 satisfy the above-mentioned formula 3 with respect to the beam-combining grating 12C. Further, the concave mirror 16 is aligned to the optical axis. For example, the position of the semiconductor laser 11-1, of which minus first diffraction beam is used for the combined laser beam L2, is aligned such that the beam axis of the laser beam L1-1 reflected with high reflectivity by the concave mirror 16 coincides with the direction in which minus first diffraction beam is outputted when the laser beam L1-1 is incident on the beam-combining grating 12C with an incident angle β=0°. Similarly, for example, the position of the semiconductor laser 11-3, of which plus first diffraction beam is used for the combined laser beam L2, is aligned such that the beam axis of the laser beam L1-3 reflected with high reflectivity by the concave mirror 16 coincides with the direction in which plus first diffraction beam is outputted when the laser beam L1-3 is incident on the beam-combining grating 12C with an incident angle β=0°. Further, in the sixth embodiment, zeroth order diffraction beam of the laser beam L1-2, for example, is used for the combined laser beam L2. Accordingly, the semiconductor laser 11-2 is disposed such that the axis of the outputted laser beam L1-2 coincides with the optical axis. Here, the optical axis refers to the optical axis of the optical system in the master oscillator system 10F.

The collimated laser beams L1-1 through L1-3 are outputted as the combined laser beam L2 via the concave mirror 16 and the beam-combining grating 12C. Accordingly, the combined laser beam L2 in accordance with the sixth embodiment is a collimated beam having a predetermined beam diameter. The combined laser beam L2 having the predetermined beam diameter is reflected with high reflectivity by a concave mirror 17 disposed to a side to which the laser beam is outputted from the beam-combining grating 12C, and is focused at a position distanced from the concave mirror 17 by the focal distance f2 of the concave mirror 17.

Disposed at the focal position of the concave mirror 17 is an input end of the optical fiber 15 that introduces the laser beam into the regenerative amplifier 20 (see FIG. 4). Accordingly, the combined laser beam L2 focused at the focal position of the concave mirror 17 is propagated to the regenerative amplifier 20 via the optical fiber 15.

As has been described so far, in the sixth embodiment, similarly to the embodiments (including the modifications thereof) described above, the laser beams L1-1 through L1-n of at least one wavelength outputted from the semiconductor lasers 11-1 through 11-n, of which the intensity of a laser beam to be outputted therefrom can easily be controlled, are combined using the beam-combining grating, which is a diffraction grating, as the beam combiner; thus, the driver laser 2 including the master oscillator system, of which the intensity of a laser beam to be outputted therefrom can easily be controlled and which is reduced in size, can be achieved.

Further, according to the sixth embodiment, even when the divergence angles of the laser beams L1-1 through L1-n outputted from the respective semiconductor lasers 11-1 through 11-n are relatively large, the laser beams L1-1 through L1-n can be focused and introduced into the regenerative amplifier 20 as the combined laser beam L2. This makes it possible to increase the intensity of the combined laser beam L2 to be inputted into the regenerative amplifier 20. As a result, the gain efficiency in the regenerative amplifier 20 is increased, whereby the following effects can be obtained, for example. First, the intensity of the laser beam inputted into the regenerative amplifier is high, whereby it is possible to amplify the inputted laser beam while substantially maintaining the pulse shape thereof. Second, the intensity of the laser beam inputted into the regenerative amplifier is high, whereby parasitic oscillation or self-oscillation can be suppressed. Third, the intensity and the pulse shape of a laser beam amplified in the regenerative amplifier can further be amplified efficiently by an amplifier disposed downstream of the regenerative amplifier. As a result, energy-saving in the regenerative amplifier 20, the amplifier 30, the pre-amplifier PA, the main amplifier MA, and the like can be achieved. Fourth, focusing performance of the pulsed amplified laser beam L2-4 with which the target material D is irradiated inside the EUV chamber 40 (see FIG. 4) is maintained, whereby the EUV light L3 with high intensity can be obtained stably.

Further, according to the sixth embodiment, the semiconductor lasers 11-1 through 11-n are disposed such that the beam axes thereof are parallel with one another, and each of the outputted laser beams is collimated, which can be combined. Accordingly, the concave mirror 16 and the semiconductor lasers 11-1 through 11-n can be arranged with respect to the beam-combining grating 12C as desired with relative ease.

The wavelength of a laser beam outputted from a semiconductor laser, such as a quantum cascade laser, is approximately 10 μm, which is invisible. Thus, it is extremely difficult to accurately align a semiconductor laser visually. In such a case, the optical elements, such as the concave mirrors 16 and 17, the beam-combining grating 12C, and the like, can be aligned in advance using, for example, zeroth order diffraction beam of a visible beam outputted from a semiconductor laser, a He—Ne laser, or the like, and thereafter the semiconductor laser may be disposed, whereby the driver laser 2 can be assembled with relative ease. Note that this method can be applied to other driver lasers in accordance with other embodiments and the modifications thereof in this disclosure.

### Seventh Embodiment

Next, a master oscillator system in accordance with a seventh embodiment of this disclosure will be described in detail below. An EUV light generation apparatus and a driver laser including the master oscillator system in accordance with the seventh embodiment are configured similarly to the EUV light generation apparatus and the driver laser in accordance with the first embodiment described above.

In the sixth embodiment described above, the beam combiner 12 including an optical system in which the concave mirrors 16 and 17 and the beam-combining grating 12C are combined is used to combine the laser beams L1-1 through L1-n outputted from the respective semiconductor lasers 11-1 through 11-n with divergence and to focus the combined laser beam. On the other hand, in the seventh embodiment, the laser beams L1-1 through L1-n outputted from the respective semiconductor lasers 11-1 through 11-n with divergence are combined and focused with a single optical element. That is, a diffraction grating having a concave spherical, ellipsoidal, or toroidal surface with grooves formed thereon (concave surface beam-combining grating 12D to be described later) is used as the beam combiner 12. With this, the plurality of the laser beams can be combined efficiently with such single optical element as described above. As a result, the master oscillator system can be reduced in size.

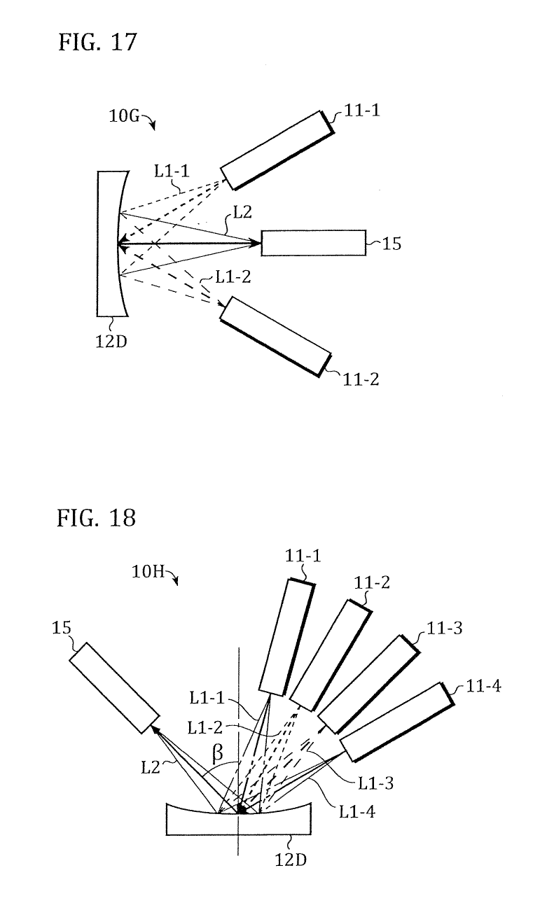

FIG. 17 schematically illustrates a configuration of the master oscillator system in accordance with the seventh embodiment. As shown in FIG. 17, with a master oscillator system 10G in accordance with the seventh embodiment, the laser beams L1-1 and L1-2 outputted from the respective semiconductor lasers 11-1 and 11-2 with divergence are incident on the same region in the diffraction surface of the concave surface beam-combining grating 12D, which is a diffraction grating having a concave spherical, ellipsoidal, or toroidal surface with grooves formed thereon. The semiconductor lasers 11-1 and 11-2 are disposed with respect to the concave surface beam-combining grating 12D such that the plus/minus m-th order diffraction beams (plus/minus first order diffraction beams, for example) of the laser beams L1-1 and L1-2 are focused at a position where the optical fiber 15 is disposed by the concave surface beam-combining grating 12D. That is, the concave surface beam-combining grating 12D is disposed such that diffraction images at output ports of the semiconductor lasers (11-1 and 11-2) are superimposed on each other and imaged at the input end of the optical fiber 15. Note that the direction in which the combined laser beam L1 is outputted substantially coincides with the optical axis of the concave surface beam-combining grating 12D.

Disposed at the focal position of the concave surface beam-combining grating 12D is the input end of the optical fiber 15 that introduces the laser beam to the regenerative amplifier 20 disposed downstream thereof (see FIG. 4). Accordingly, the combined laser beam L2 focused at the focal position of the concave surface beam-combining grating 12D is propagated to the regenerative amplifier 20 via the optical fiber 15.

As has been described so far, in the seventh embodiment, similarly to the embodiments (including the modifications thereof) described above, the configuration is such that the laser beams L1-1 through L1-n of at least one wavelength outputted from the semiconductor lasers 11-1 through 11-n, of which the intensity of a laser beam to be outputted therefrom can easily be controlled, are combined using the beam-combining grating, which is a diffraction grating, as the beam combiner. Accordingly, a driver laser including the master oscillator system, of which the intensity of a laser beam to be outputted therefrom can easily be controlled and which is reduced in size, can be achieved.

Further, according to the seventh embodiment, the laser beams L1-1 through L1-n outputted from the respective semiconductor lasers 11-1 through 11-n with divergence can be focused without the need for a concave mirror, a collimator lens, or the like, and be propagated as the combined laser beam L2 to the regenerative amplifier 20 via the optical fiber. That is, a similar effect as those of the above-described fifth and sixth embodiments can be obtained with a single optical element. With this, in comparison to the embodiment shown in FIG. 16, the master oscillator system can be reduced in size.

### Eighth Embodiment

Next, a master oscillator system in accordance with an eighth embodiment of this disclosure will be described in detail below. An EUV light generation apparatus and a driver laser including the master oscillator system in accordance with the eighth embodiment are configured similarly to the EUV light generation apparatus and the driver laser in accordance with the first embodiment described above.

In the seventh embodiment described above, the semiconductor lasers 11-1 through 11-n are disposed with respect to the concave surface beam-combining grating 12D such that the combined laser beam L2 is outputted in a direction parallel to the normal line that passes through the lowermost point on the concave surface of the concave surface beam-combining grating 12D. On the other hand, in the eighth embodiment, the semiconductor lasers 11-1 through 11-n are disposed with respect to the concave surface beam-combining grating 12D such that the combined laser beam L2 is outputted in a direction inclined to the normal line that passes through the lowermost point on the concave surface of the beam-combining grating 12D. With this, similarly to the seventh embodiment described above, the laser beams L1-1 through L1-n outputted from the respective semiconductor lasers 11-1 through 11-n with divergence can be combined, and the optical system for focusing the laser beams L1-1 through L1-n can be configured of a single optical element. As a result, the master oscillator system can be reduced in size.

FIG. 18 schematically illustrates a configuration of the master oscillator system in accordance with the eighth embodiment. As shown in FIG. 18, in a master oscillator system 10H in accordance with the eighth embodiment, the semiconductor lasers 11-1 through 11-4 are disposed with respect to the concave surface beam-combining grating 12D such that the laser beams L1-1 through L1-4 outputted from the respective semiconductor lasers 11-1 through 11-4 with divergence are incident on the same region in the concave surface of the concave surface beam-combining grating 12D, which is a diffraction grating with grooves formed on the concave surface thereof, and plus/minus m-th order diffraction beams of the laser beams L1-1 through L1-4 are focused by the concave surface beam-combining grating 12D at the input end of the optical fiber 15. Here, the laser beams L1-1 through L1-4 outputted from the respective semiconductor lasers 11-1 through 11-4 are incident on the concave surface beam-combining grating 12D with their respective angles α₁₁₋₁ through α₁₁₋₄. Further, the concave surface beam-combining grating 12D is disposed such that the diffraction angles β of the diffraction beams of differing orders coincide with one another. That is, the concave surface beam-combining grating 12D is disposed such that the diffraction images at the output ports of the semiconductor lasers 11-1 through 11-4 are superimposed on one another by the concave surface beam-combining grating 12D and is imaged at the input end of the optical fiber 15. This, in comparison to the case of the first embodiment, makes it possible to increase the differences Δα in incident angles of the adjacent laser beams L1-1 through L1-4. In the first embodiment, the laser beams L1-1 through L1-n are incident on the beam-combining grating with the respective incident angles α₋₁, and are diffracted with the same diffraction angle β, under the condition of the same diffraction order (for example, m=−1) (see, FIG. 3). In this case, the difference Δα in incident angles of the adjacent laser beams L1-1 through L1-n is small.

In the eighth embodiment, even when the distance between the beam-combiner 12 and the semiconductor lasers 11-1 through 11-n is relatively short, the adjacent semiconductor lasers 11-1 through 11-n can be disposed on the same plane with the semiconductor lasers 11-1 through 11-n being spaced apart from one another, and as a result, the master oscillator system can be reduced in size.

Further, disposed at the position where the combined laser beam L2 that have been diffracted by the concave surface beam-combining grating 12D is focused is the input end of the optical fiber 15 that introduced the laser beam to the regenerative amplifier 20 disposed downstream thereof (see FIG. 4). Accordingly, the combined laser beam L2 focused at the focal position of the concave surface beam-combining grating 12D is propagated to the regenerative amplifier 20 via the optical fiber 15.

As has been described so far, in the eighth embodiment, similarly to the embodiments (including the modifications thereof) described above, the configuration is such that the laser beams L1-1 through L1-n of at least one wavelength outputted from the respective semiconductor lasers 11-1 through 11-n, of which the intensity of a laser beam to be outputted therefrom can easily be controlled, are combined using the beam-combining grating, which is a diffraction grating, as the beam combiner. Accordingly, the master oscillator system, of which the intensity of a laser beam to be outputted therefrom can easily be controlled and which is reduced in size, can be achieved.

Further, in accordance with the eighth embodiment, as in the seventh embodiment described above, the laser beams L1-1 through L1-n outputted from the respective semiconductor lasers 11-1 through 11-n with divergence can be focused without the need for a concave mirror, a collimator lens, or the like, and be propagated as the combined laser beam L2 to the regenerative amplifier 20 via the optical fiber. That is, similar effects as those of the above-described fifth and sixth embodiments can be obtained with a single optical element. With this, in comparison to the embodiment shown in FIG. 16, the master oscillator system can be reduced in size.

### Ninth Embodiment

Next, a master oscillator system in accordance with a ninth embodiment of this disclosure will be described in detail below. An EUV light generation apparatus and a driver laser including the master oscillator system in accordance with the ninth embodiment are configured similarly to the EUV light generation apparatus and the driver laser in accordance with the first embodiment described above.

In the first through eighth embodiments described above, a diffraction grating on which the plurality of the slits or elongated grooves are formed in parallel with one another has been used as the beam combiner 12. Accordingly, in the first through eighth embodiments described above, the beam combiner has been configured such that plus/minus m-th order diffraction beams of the incident beam L appear on a plane including the direction in which the slits or grooves are formed on the beam combiner 12 and the line normal to the diffraction surface of the beam combiner 12. In other words, plus/minus m-th order diffraction beams have been outputted two-dimensionally from the beam combiner 12 so as to be propagated within a plane including the direction in which the slits are arranged on the beam combiner 12 and the line normal to the diffraction surface of the beam combiner 12. Thus, in the first through eighth embodiments described above, the semiconductor lasers 11-1 through 11-n have been aligned two-dimensionally on a plane including the direction in which the slits or grooves are formed on the beam combiner 12 and the line normal to the diffraction surface of the beam combiner 12.

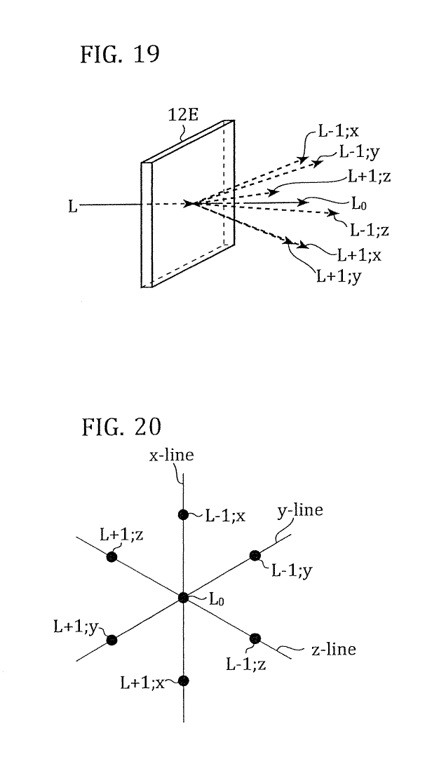

On the other hand, in the ninth embodiment, as shown in FIGS. 19 and 20, a diffractive optical element (DOE) 12E, which enables plus/minus first order diffraction beams of the incident beam L to appear three-dimensionally, is used as the beam combiner 12. A microelectromechanical system (MEMS) may be used for the DOE 12E, and a concavo-convex pattern is formed on a principal surface of a transparent substrate made of ZnSe, which enables both the function of a collimator lens and the function of a diffraction grating to be achieved near the wavelength of, for example, 10.6 μm. FIG. 19 schematically illustrates zeroth and plus/minus first order diffraction beams of a laser beam incident on the DOE with an incident angle β=0° in accordance with the ninth embodiment. FIG. 20 schematically illustrates an arrangement of plus/minus first order diffraction beams of a laser beam incident on the DOE in accordance with the ninth embodiment, the diffraction beams appearing on a plane perpendicular to the beam axis of zeroth order diffraction beam. Further, in the ninth embodiment, as shown in FIGS. 19 and 20, a case where plus/minus first order diffraction beams appear on vertices, respectively, of a hexagon with zeroth order diffraction beam being located at the center thereof, the vertices, in other words, being points where a circle with zeroth order diffraction beam being the center thereof intersect with each of x-, y-, and z-lines, which intersect with one another at 60° and pass through zeroth order diffraction beam, is shown as an example.

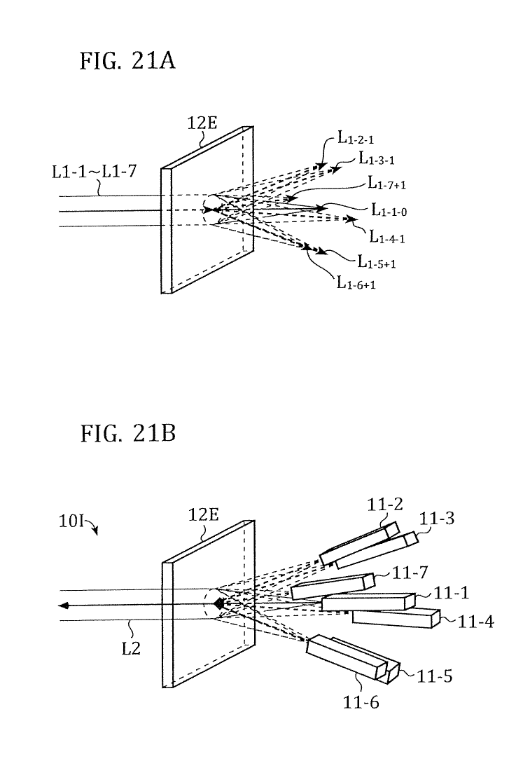

FIG. 21A schematically illustrates laser beams transmitted and diffracted as the collimated laser beams L1-1 through L1-7 are incident on the DOE 12E with an incident angle β=0°. As shown in FIGS. 19 and 20, the diffraction beams appear as plus/minus first order diffraction beams (L₁₋₂₋₁, L₁₋₃₋₁, L₁₋₄₋₁, L₁₋₅₊₁, L₁₋₆₊₁, L₁₋₇₊₁) on the points where the circle with zeroth order diffraction beam L₁₋₁₋₀ intersects with the X-, y-, and z-lines, which intersect with one another at 60° and pass through zeroth order diffraction beam L₁₋₁₋₀. These diffraction beams are focused at respective predetermined positions.

On the other hand, in FIG. 21B, the output ends of the semiconductor lasers are disposed at respective focal positions of the above diffraction beams, and the semiconductor lasers L1-1 through L1-7 are disposed such that the laser beams L1-1 through L1-7 outputted therefrom are incident with angles which are equal to the diffraction angles with which zeroth (L₁₋₁₋₀) and plus/minus first order diffraction beams (L₁₋₂₋₁, L₁₋₃₋₁, L₁₋₄₋₁, L₁₋₅₊₁, L₁₋₆₊₁, L₁₋₇₊₁) have appeared in each of the different directions (x-, y-, z-lines) in the configuration shown in FIG. 21A. Accordingly, with a master oscillator system 101 in accordance with the ninth embodiment, the laser beams L1-1 through L1-7 outputted from the respective semiconductor lasers 11-1 through 11-7 are incident on the DOE 12E with angles corresponding to the respective diffraction angles assigned for each of the laser beams. As a result, the combined laser beam L2, which is a collimated beam in which the laser beams L1-1 through L1-7 are combined, is outputted from the DOE 12E.

As has been described so far, in the ninth embodiment, similarly to the embodiments (including the modifications thereof) described above, the laser beams L1-1 through L1-7 of at least one wavelength outputted from the respective semiconductor lasers 11-1 through 11-7, of which the intensity of a laser beam to be outputted therefrom can easily be controlled, are combined using the DOE as the beam combiner; thus, the master oscillator system, of which the intensity of a laser beam to be outputted therefrom can easily be controlled and which is reduced in size, can be achieved.

Further, according to the ninth embodiment, the laser beams L1-1 through L1-n outputted from the respective semiconductor lasers 11-1 through 11-n with divergence can be diffracted and propagated to the regenerative amplifier 20 as the collimated combined laser beam L2, without the need for a concave mirror, a collimator lens, or the like. With this, the master oscillator system can be reduced in size. Furthermore, according to the ninth embodiment, the semiconductor lasers 11-1 through 11-n can be arranged three-dimensionally, whereby the master oscillator system can be designed more compactly.

### Tenth Embodiment

Next, a master oscillator system in accordance with a tenth embodiment of this disclosure will be described in detail below. An EUV light generation apparatus and a driver laser including the master oscillator system in accordance with the tenth embodiment are configured similarly to the EUV light generation apparatus and the driver laser in accordance with the first embodiment described above.

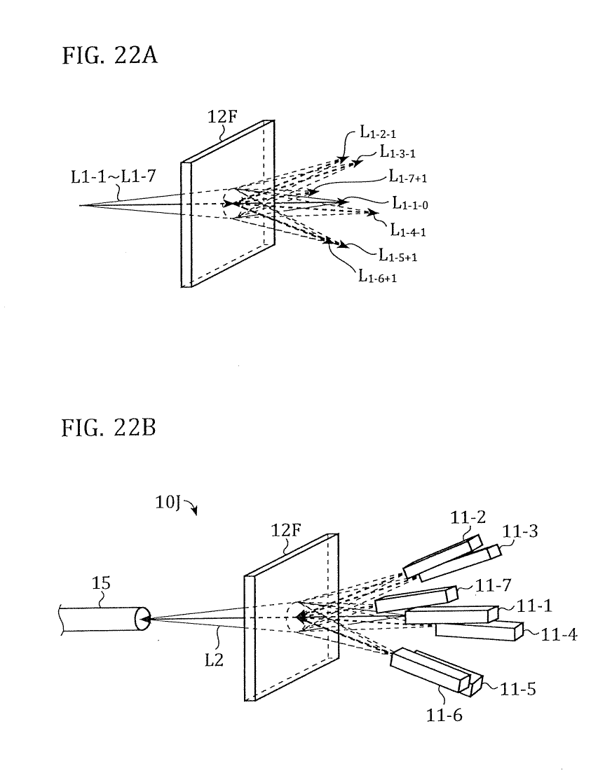

In the ninth embodiment described above, the DOE 12E has a function of a so-called collimator lens; that is, the COE 12E combines the laser beams L1-1 through L1-7 incident thereon and outputs the combined laser beam L2 as a collimated beam. On the other hand, in the tenth embodiment, as in a DOE 12E shown in FIG. 22A, a concavo-convex pattern functioning as a collimator lens and a focusing lens is formed, using the MEMS, on a principal surface of a transparent substrate made, for example, of ZnSe. With this, the DOE 12E, in which zeroth and plus/minus first order diffraction beams of the incident beam L are outputted three-dimensionally in each of the x-, y-, z-lines, is achieved. FIG. 22A schematically illustrates the plurality of the diffraction beams (zeroth and plus/minus first order diffraction beams in each direction) of the laser beam having divergence incident on the DOE 12E with an incident angle β=0° in accordance with the tenth embodiment.

FIG. 22B schematically illustrates a configuration of the master oscillator system in accordance with the tenth embodiment. The laser beams L1-1 through L1-7 outputted from the respective semiconductor lasers 11-1 through 11-7 are incident on the DOE 12E with incident angles corresponding to the directions assigned for each of the laser beams L1-1 through L1-7. Here, in FIG. 22B, the directions assigned for each of the laser beams L1-1 through L1-7 are the directions in which zeroth (L₁₋₁₋₀) and plus/minus first order diffraction beams (L₁₋₂₋₁, L₁₋₃₋₁, L₁₋₄₋₁, L₁₋₅₊₁, L₁₋₆₊₁, L₁₋₇₊₁) in different directions x-line, y-line, z-line) have appeared in the configuration shown in FIG. 22A. The laser beams L1-1 through L1-7 are incident on the DOE 12E in their respective assigned directions, whereby the diffraction angles of the laser beams L1-1 through L1-7 are made to coincide with one another by the DOE 12E and the laser beams L1-1 through L1-7 are combined. Here, not only does the DOE 12E diffract the laser beams, but it also has a function of imaging an object at a predetermined position. Here, the semiconductor lasers 11-1 through 11-7, the DOE 12E, and the optical fiber 15 are disposed such that the diffraction images at the output ports of the semiconductor lasers are superimposed on one another and imaged at the input end of the optical fiber 15.

As has been described so far, in the tenth embodiment, similarly to the embodiments (including the modifications thereof) described above, the laser beams L1-1 through L1-7 of at least one wavelength outputted from the respective semiconductor lasers 11-1 through 11-7, of which the intensity of a laser beam to be outputted therefrom can easily be controlled, are combined using the DOE as the beam combiner; thus, the master oscillator system, of which the intensity of a laser beam to be outputted therefrom can easily be controlled and which is reduced in size, can be achieved.

Further, according to the tenth embodiment, the laser beams L1-1 through L1-7 outputted from the respective semiconductor lasers 11-1 through 11-7 with divergence can be diffracted, focused, and propagated to the regenerative amplifier 20 as the combined laser beam L2 without the need for a concave mirror, a collimator lens, or the like. With this, the master oscillator system can be reduced in size. Furthermore, according to the tenth embodiment, similarly to the ninth embodiment described above, the semiconductor lasers 11-1 through 11-7 can be arranged three-dimensionally, whereby the master oscillator system can be designed more compactly.

### Eleventh Embodiment

Next, a master oscillator system in accordance with an eleventh embodiment of this disclosure will be described in detail below. An EUV light generation apparatus and a driver laser including the master oscillator system in accordance with the eleventh embodiment are configured similarly to the EUV light generation apparatus and the driver laser in accordance with the first embodiment described above.

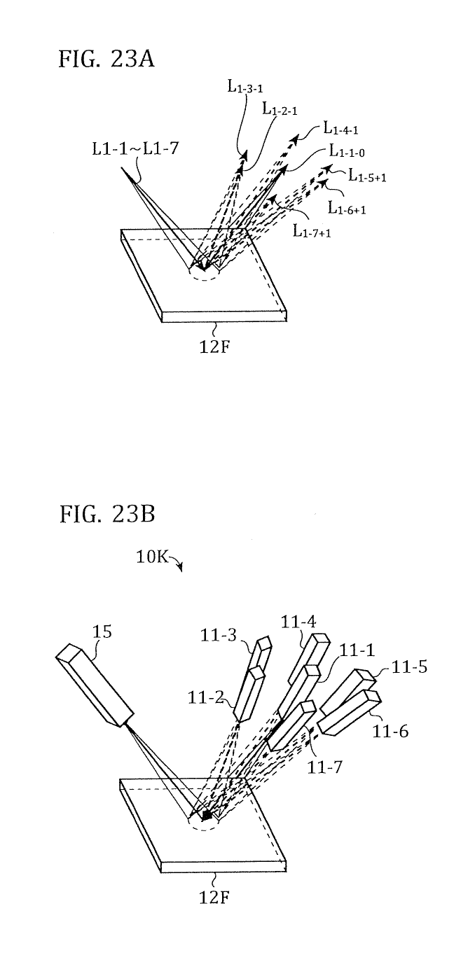

In the tenth embodiment described above, the semiconductor lasers 11-1 through 11-7 are disposed with respect to the DOE 12F such that the combined laser beam L2 is outputted from the DOE 12F with an angle β=0°. In the eleventh embodiment, on the other hand, as shown in FIG. 23B, the semiconductor lasers 11-1 through 11-7 are disposed with respect to the DOE 12F such that the combined laser beam L2 is outputted in a direction inclined to the surface of the DOE 12F. FIG. 23A schematically illustrates zeroth and plus/minus first order diffraction beams of a laser beam incident on the DOE 12F with an angle β in accordance with the eleventh embodiment.

FIG. 23B schematically illustrates a configuration of a master oscillator system 10K in accordance with the eleventh embodiment. The laser beams L1-1 through L1-7 outputted from the respective semiconductor lasers 11-1 through 11-7 are incident on the DOE 12F with incident angles corresponding to those of the assigned directions. Here, in FIG. 23A, the assigned directions for each of the laser beams L1-1 through L1-7 are the directions in which zeroth (L₁₋₁₋₀) and plus/minus first order diffraction beams (L₁₋₂₋₁, L₁₋₃₋₁, L₁₋₄₋₁, L₁₋₅₊₁, L₁₋₆₊₁, L₁₋₋₇₊₁) in different directions (x-line, y-line, z-line) have appeared in the configuration shown in FIG. 23A. The laser beams L1-1 through L1-7 are incident on the DOE 12F in their respective assigned directions, whereby the reflective diffraction angles are made to coincide with one another by the DOE 12F and the laser beams L1-1 through L1-7 are combined. Here, not only does the DOE 12F diffract the laser beams, but it also has a function of imaging an object at a predetermined position. Here, the semiconductor lasers 11-1 through 11-7, the DOE 12F, and the optical fiber 15 are arranged such that the diffraction images at the output ports of the semiconductor lasers L1-1 through L1-7 are superimposed on one another and imaged at the input end of the optical fiber 15.

As has been described so far, in the eleventh embodiment, similarly to the embodiments (including the modifications thereof) described above, the laser beams L1-1 through L1-7 of at least one wavelength outputted from the respective semiconductor lasers 11-1 through 11-7, of which the intensity of a laser beam to be outputted therefrom can easily be controlled, are combined using the DOE as the beam combiner; thus, the master oscillator system, of which the intensity of a laser beam to be outputted therefrom can easily be controlled and which is reduced in size, can be achieved.

Further, according to the eleventh embodiment, similarly to the tenth embodiment described above, the laser beams L1-1 through L1-7 outputted from the respective semiconductor lasers 11-1 through 11-7 with divergence can be diffracted, focused, and propagated to the regenerative amplifier 20 as the combined laser beam L2 without the need for a concave mirror, a collimator lens, or the like. With this, the master oscillator system can be reduced in size. Furthermore, according to the eleventh embodiment, similarly to the ninth embodiment described above, the semiconductor lasers 11-1 through 11-7 can be arranged three-dimensionally, whereby the master oscillator system can be designed more compactly.

### Twelfth Embodiment

Next, a master oscillator system in accordance with a twelfth embodiment of this disclosure will be described in detail below. An EUV light generation apparatus and a driver laser including the master oscillator system in accordance with the twelfth embodiment are configured similarly to the EUV light generation apparatus and the driver laser in accordance with the first embodiment described above.

In the first through eleventh embodiments described above, the output ports of the semiconductor lasers 11-1 through 11-n constitute the output ends of the laser beams L1-1 through 11-n. On the other hand, in the twelfth embodiment, first ends of the optical fibers 19-1 through 19-n are connected to the respective output ports of the semiconductor lasers 11-1 through 11-n, whereby the second ends of the optical fibers 19-1 through 19-n constitute the output ends of the laser beams L1-1 through L1-n. With this, in the twelfth embodiment, flexibility of the optical fibers 19-1 through 19-n makes it possible to arrange the semiconductor lasers 11-1 through 11-n more freely. As a result, the master oscillator system can be designed more compactly, and the master oscillator system can be reduced in size.

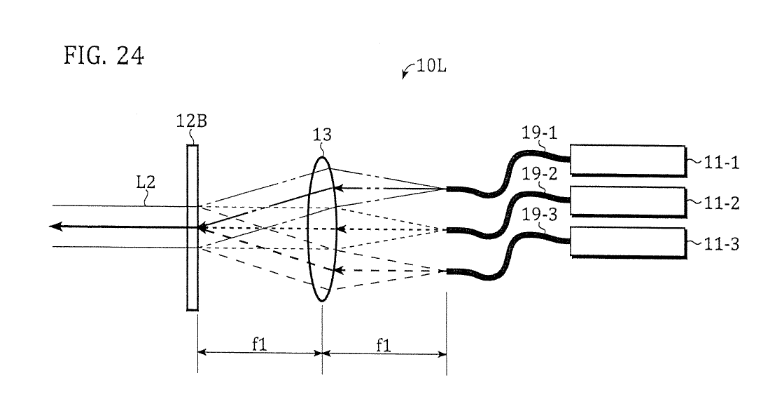

FIG. 24 schematically illustrates a configuration of the master oscillator system in accordance with the twelfth embodiment. As shown in FIG. 24, a master oscillator system 10L in accordance with the twelfth embodiment is configured such that first ends of the optical fibers 19-1 through 19-3 are connected to the respective output ports of the semiconductor lasers 11-1 through 11-3 which output the laser beams L1-1 through L1-3, respectively. Note that other configurations are similar to those of the master oscillator system 10E in accordance with the fifth embodiment described above; thus, the duplicate descriptions thereof will be omitted here.

The laser beams L1-1 through L1-3 are outputted from the second ends of the optical fibers 19-1 through 19-3 which propagate the respective semiconductor laser beams. The laser beams outputted from the respective optical fibers are collimated by the collimator lens 13. Then, the collimated laser beams are superimposed on one another on the diffraction surface of the beam-combining grating 12B. At this time, similarly to the fifth embodiment described above, the second ends of the optical fibers 19-1 through 19-3 are aligned on the front focal plane of the collimator lens 13 so that the output axes of the laser beams L1-1 through 11-3 are parallel with one another. Then, the beam-combining grating 12B is disposed such that the diffraction surface thereof coincides with the rear focal plane of the collimator lens 13.

Further, similarly to the semiconductor lasers 11-1 through 11-3 in accordance with the fifth embodiment described above, the positions of the second ends of the optical fibers 19-1 through 19-3 are aligned on the front focal plane of the collimator lens 13 such that the beam axes of the laser beams L1-1 through L1-3, of which the beam axes have been modified by the collimator lens 13, satisfies the above-mentioned formula 3 with respect to the beam-combining grating 12B. As a result, the beam spots of the laser beams L1-1 through L1-3 formed on the diffraction surface of the beam-combining grating 12B can be superimposed on one another. Note that, in the twelfth embodiment as well, when the collimator lens 13 is a thin lens, for example, the collimator lens 13 is disposed at an intermediary position between the beam-combining grating 12B and the second ends of the optical fibers 19-1 through 19-3. Here, the distance between the beam-combining grating 12B and the second ends of the optical fibers 19-1 through 19-3 is twice the focal distance f1 of the collimator lens 13.

With such configuration as described above, according to the twelfth embodiment, similar effects as those of the fifth embodiment can be obtained, and the master oscillator system can be designed even more freely, which makes it possible to design the master oscillator system more compactly, whereby the master oscillator system can be reduced in size.

### Thirteenth Embodiment

Next, a master oscillator system in accordance with a thirteenth embodiment of this disclosure will be described in detail below. An EUV light generation apparatus and a driver laser including the master oscillator system in accordance with the thirteenth embodiment are configured similarly to the EUV light generation apparatus and the driver laser in accordance with the first embodiment.

In the twelfth embodiment described above, a case where the configuration in which the second ends of the optical fibers 19-1 through 19-n, of which the first ends are connected to the output ports of the semiconductor lasers 11-1 through 11-n, are used as the output ports for the laser beams L1-1 through L1-n is combined with the fifth embodiment described above has been shown as an example. On the other hand, in the thirteenth embodiment, a case where the configuration in which the second ends of the optical fibers 19-1 through 19-n, of which the first ends are connected to the output ports of the semiconductor lasers 11-1 through 11-n, are used as the output ports for the laser beams L1-1 through L1-n is combined with the sixth embodiment described above will be shown as an example.

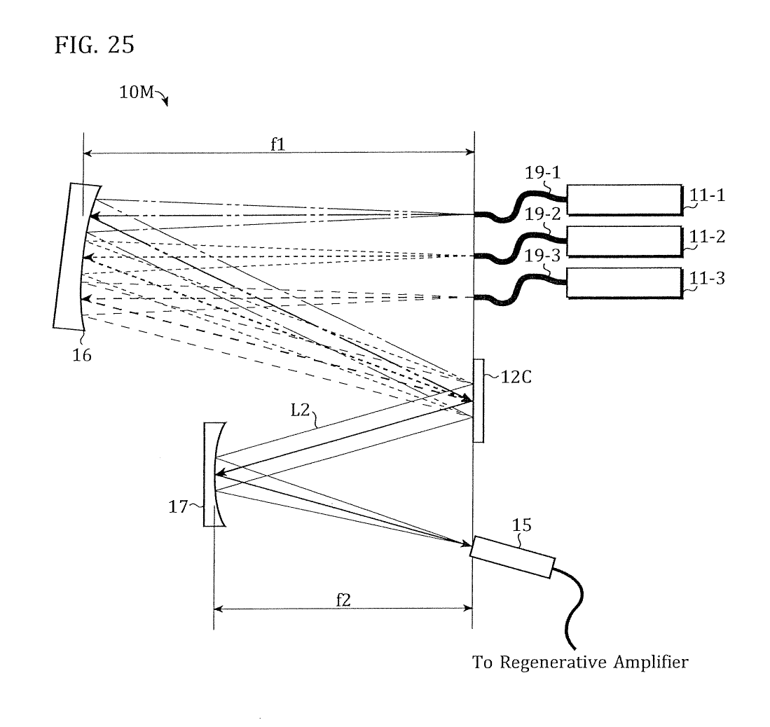

FIG. 25 schematically illustrates a configuration of the master oscillator system in accordance with the thirteenth embodiment. As shown in FIG. 25, a master oscillator system 10M in accordance with the thirteenth embodiment is configured such that first ends of the optical fibers 19-1 through 19-3 are connected to the output ports of the semiconductor lasers 11-1 through 11-3, which output the respective laser beams L1-1 through L1-3. Other configurations are similar to those of the master oscillator system 10E in accordance with the sixth embodiment described above; thus, the duplicate descriptions thereof will be omitted here.

The laser beams L1-1 through L1-3 are outputted from the second ends of the optical fibers 19-1 through 19-3, which propagate the respective semiconductor laser beams. The laser beams outputted from the respective optical fibers are collimated by the concave mirror 16. Then, the collimated laser beams are superimposed on one another on the diffraction surface of the beam-combining grating 12C. At this time, the second ends of the optical fibers 19-1 through 19-3 are aligned on the front focal plane of the concave mirror 16 so that the output axes of the laser beams L1-1 through 11-3 are parallel with one another. Then, the beam-combining grating 12C is disposed such that the diffraction surface thereof coincides with the rear focal plane of the concave mirror 16. For example, the focal distance of the concave mirror 16 being f1, the concave mirror 16 and the second ends of the optical fibers 19-1 through 19-3, and the concave mirror 16 and the beam-combining grating 12C are each disposed to oppose each other with the focal distance f1 spaced apart therebetween. Further, similarly to the semiconductor lasers 11-1 through 11-3 in accordance with the sixth embodiment described above, the positions of the second ends of the optical fibers 19-1 through 19-3 are aligned on the focal plane of the concave mirror 16 such that the beam axes of the laser beams L1-1 through L1-3, of which the beam axes have been modified by the concave mirror 16, satisfies the above-mentioned formula 3 with respect to the beam-combining grating 12C. As a result, the concave mirror 16 is capable of superimposing the beam spots of the laser beams L1-1 through L1-3 formed on the diffraction surface of the beam-combining grating 12C.

With such configuration as described above, according to the thirteenth embodiment, similar effects as those of the sixth embodiment described above can be obtained, and the master oscillator system can be designed even more freely, which makes it possible to design the master oscillator system more compactly, whereby the master oscillator system can be reduced in size.

### Fourteenth Embodiment

Next, a master oscillator system in accordance with a fourteenth embodiment of this disclosure will be described in detail below. An EUV light generation apparatus and a driver laser including the master oscillator system in accordance with the fourteenth embodiment are configured similarly to the EUV light generation apparatus and the driver laser in accordance with the first embodiment.

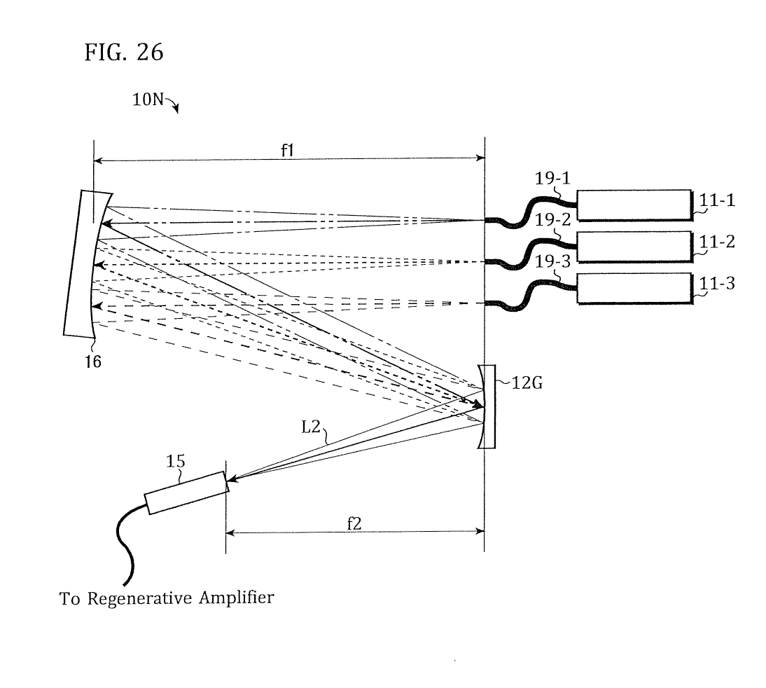

In the thirteenth embodiment described above, the beam-combining grating 12C, which is a reflective diffraction grating, has been used as the beam combiner 12 for the collimated laser beams L1-1 through L1-n. Further, the collimated combined laser beam L2 which has been combined by the beam-combining grating 12C has been focused at a predetermined position using the concave mirror 17. On the other hand, in the fourteenth embodiment, as shown in FIG. 26, a diffraction grating having a curved diffraction surface, such as a spherical surface or an off-axis paraboloidal surface (a concave surface beam-combining grating 12G), is used as the beam combiner 12. With this, in the fourteenth embodiment, the concave mirror 17 in the thirteenth embodiment described above can be omitted, whereby the configuration of the master oscillator system 10N can be simplified. FIG. 26 schematically illustrates a configuration of the master oscillator system in accordance with the fourteenth embodiment.

As has been described so far, in the fourteenth embodiment, similarly to the embodiments (including the modifications thereof) described above, the laser beams L1-1 through L1-n of at least one wavelength outputted from the respective semiconductor lasers 11-1 through 11-n, of which the intensity and the pulse width of a laser beam to be outputted therefrom can easily be controlled, are combined using the beam-combining grating, which is a diffraction grating, as the beam combiner. Accordingly, a driver laser including the master oscillator system, of which the intensity and the pulse width of a laser beam to be outputted therefrom can easily be controlled and which is reduced in size, can be achieved.

Further, in the fourteenth embodiment, similarly to the seventh embodiment described above, a configuration of an optical system for combining and focusing the laser beams L1-1 through L1-n outputted from the respective semiconductor lasers 11-1 through 11-n with divergence can be simplified, and as a result, the master oscillator system can be reduced in size. Further, according to the fourteenth embodiment, similarly to the embodiments described above, and the master oscillator system can be designed even more freely, which makes it possible to design the master oscillator system more compactly, whereby the master oscillator system can be reduced in size.

### Fifteenth Embodiment

Next, a master oscillator system in accordance with a fifteenth embodiment of this disclosure will be described in detail below. Any of the EUV light generation apparatuses and the driver lasers in accordance with the embodiments described above may be applied to the EUV light generation apparatus and the driver laser including the master oscillator system in accordance with the fifteenth embodiment. Here, a case where the EUV light generation apparatus and the driver laser in accordance with the first embodiment are employed will be shown as an example.

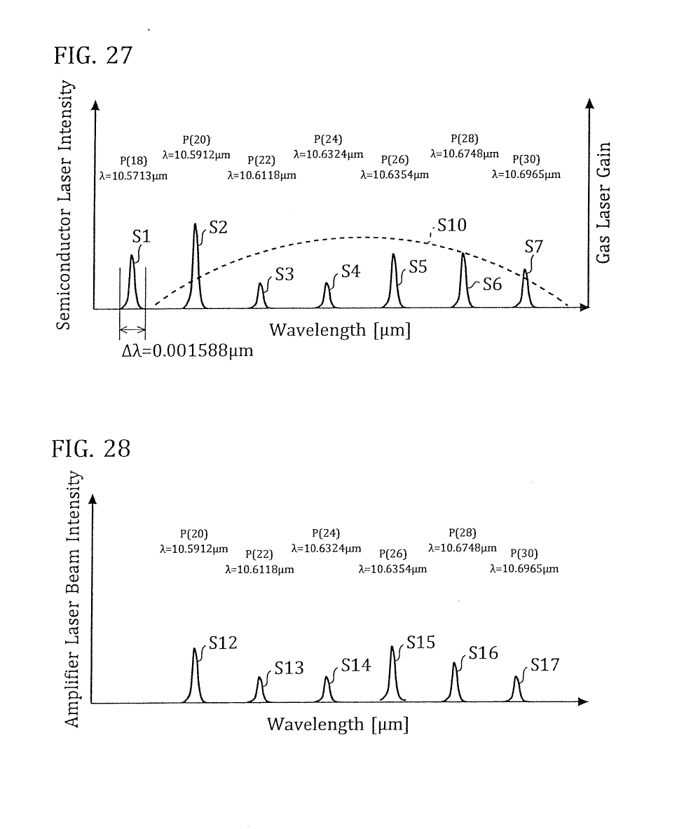

As shown in FIG. 27, the CO₂ gas gain medium 25a includes a plurality of gain bandwidths S1 through S7 (for example, modes P(18), P(20), P(22), P(24), P(26), P(28), P(30), and so forth). A width AA between each of the gain bandwidths S1 through S7 is approximately 0.0016 μm. Further, gains in the gain bandwidths S1 through S7 differ from one another.

The laser beams L1-1 through L1-n outputted from the respective semiconductor lasers 11-1 through 11-n are amplified when the wavelengths thereof coincide with any one of the gain bandwidths S1 through S7. Here, when, as indicated by the dashed line in FIG. 27, a wavelength spectral profile S10 of the laser beams L1-1 through L1-n is a broad spectral profile which is wide enough to cover from the mode P(20) to the mode P(30), as shown in FIG. 28, the laser beams which have been amplified by the CO₂ gas gain medium 25a are outputted from the laser amplification unit 25 as laser beams S12 through S17 with the intensity corresponding to the gain distribution of the gain bandwidths S2 through S7.

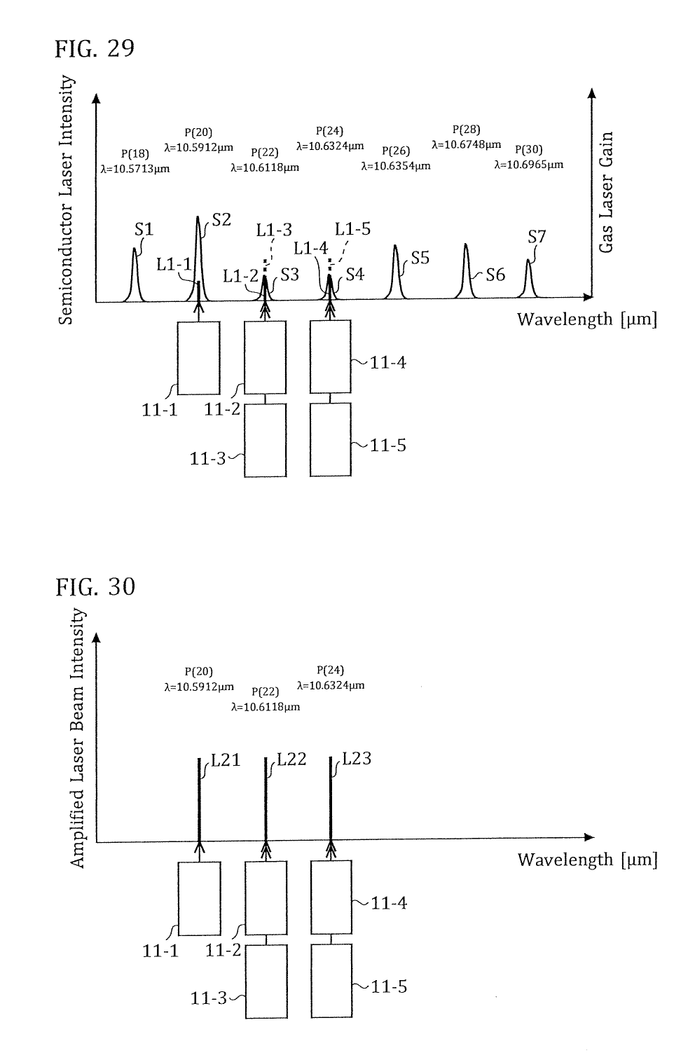

Therefore, in the fifteenth embodiment, of the laser beams L1-1 through L1-n outputted from the plurality of the semiconductor lasers 11-1 through 11-n, the intensity of the laser beams amplified in the gain bandwidth of a small gain is increased. As illustrated in FIG. 29, for example, the number of the semiconductor lasers that oscillate at wavelengths corresponding to the bandwidths S3 and S4 of a small gain is made lager than the number of the semiconductor lasers that oscillate at wavelengths corresponding to the bandwidth S2 of a large gain. With this, the intensity of the laser beams L1-2 through L1-5 amplified in the bandwidths S3 and S4 of a small gain can be increased. As a result, as shown in FIG. 30, the intensity of the laser beam L21 amplified in the gain bandwidth S2 of a large gain and the intensity of the laser beams L22 and L23 amplified in the gain bandwidths S3 and S4 of a small gain can be made substantially equal to each other.

In this way, the number of the semiconductor lasers that oscillate at a wavelength corresponding to one gain bandwidth does not have to be one, but it can be greater than one. Thus, by appropriately selecting the number of the semiconductor lasers corresponding to each of the gain bandwidths S1 through S7, various modification can be made to the wavelength spectral profiles of the amplified laser beams.

Further, adjusting the oscillation wavelengths of the semiconductor lasers 11-1 through 11-n to any of the gain bandwidths S1 through S7 makes it possible to reduce the energy consumed to oscillate at a wavelength that is not amplified in the CO₂ gas gain medium 25a of the laser amplification unit 25, whereby the power consumed at the master oscillator system can be reduced.

Other configurations, operations, and effects are similar to those of the embodiments described above or the modifications thereof; thus, duplicate descriptions thereof will be omitted here.

### Sixteenth Embodiment

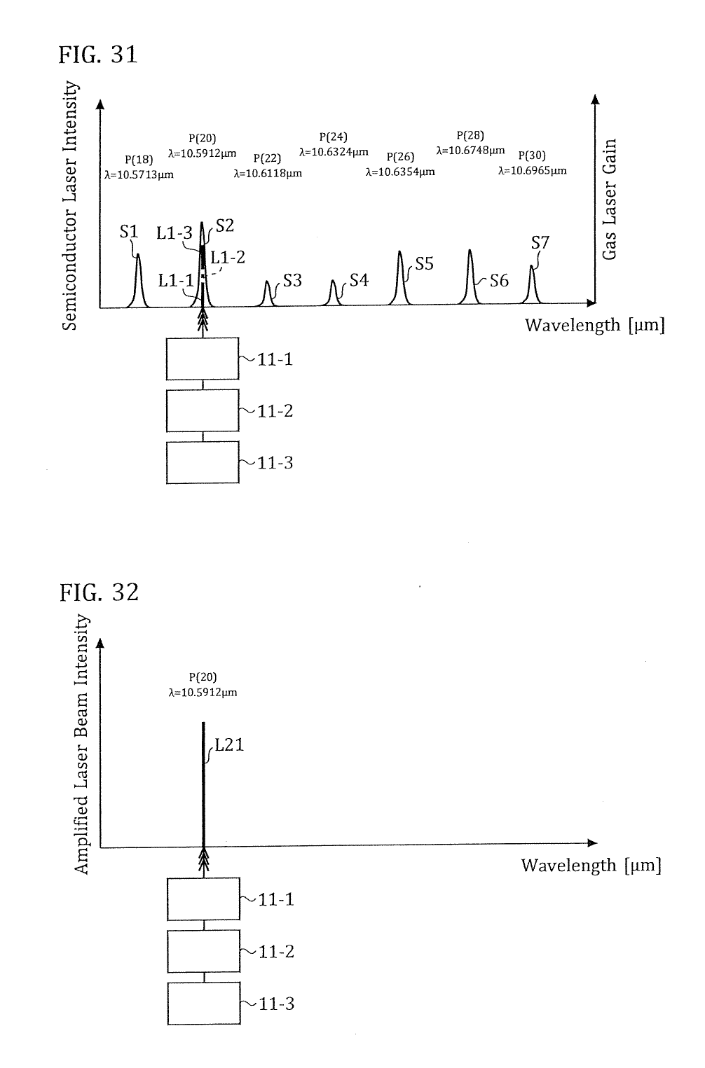

Further, the plurality of the semiconductor lasers 11-1 through 11-n may be made to oscillate at one wavelength corresponding to one gain bandwidth. As shown in FIG. 31, for example, the semiconductor lasers 11-1 through 11-3 may be made to oscillate at the wavelength corresponding to the gain bandwidth S2. With this, as shown in FIG. 32, for example, the gain bandwidth S2 of a large gain can be used selectively to efficiently amplify the laser beams.

In the fifteenth and sixteenth embodiments, a case where the semiconductor lasers 11-1 through 11-n each oscillate in a single-longitudinal mode has been shown as an example. However, the embodiments are not limited thereto. For example, any one of more of the semiconductor lasers 11-1 through 11-n can be made to oscillate in a multi-longitudinal mode. In this case, it is preferable to make the oscillation wavelengths of the multi-longitudinal mode correspond to the gain bandwidths of the CO₂ gas gain medium 25a.

### Seventeenth Embodiment

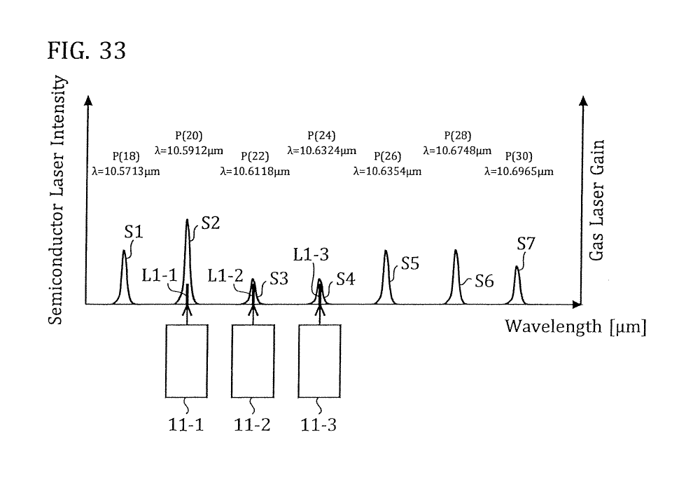

Further, in each of the embodiments described above, the plurality of the semiconductor lasers 11-1 through 11-n may output the respective laser beams L1-1 through L1-nat the same timing. Further, the intensity of the laser beams L1-1 through L1-n outputted from the respective semiconductor lasers 11-1 through 11-n does not have to be equal. For example, the intensity of the current pulses inputted to the semiconductor lasers 11-1 through 11-n may appropriately be modified in accordance with the gains in the corresponding gain bandwidths S1 through S7. Hereinafter, as shown in FIG. 33, for example, a case where the oscillation wavelengths of the semiconductor lasers 11-1 through 11-3 are made to coincide with the gain bandwidths S2 through S4 respectively is shown as an example.

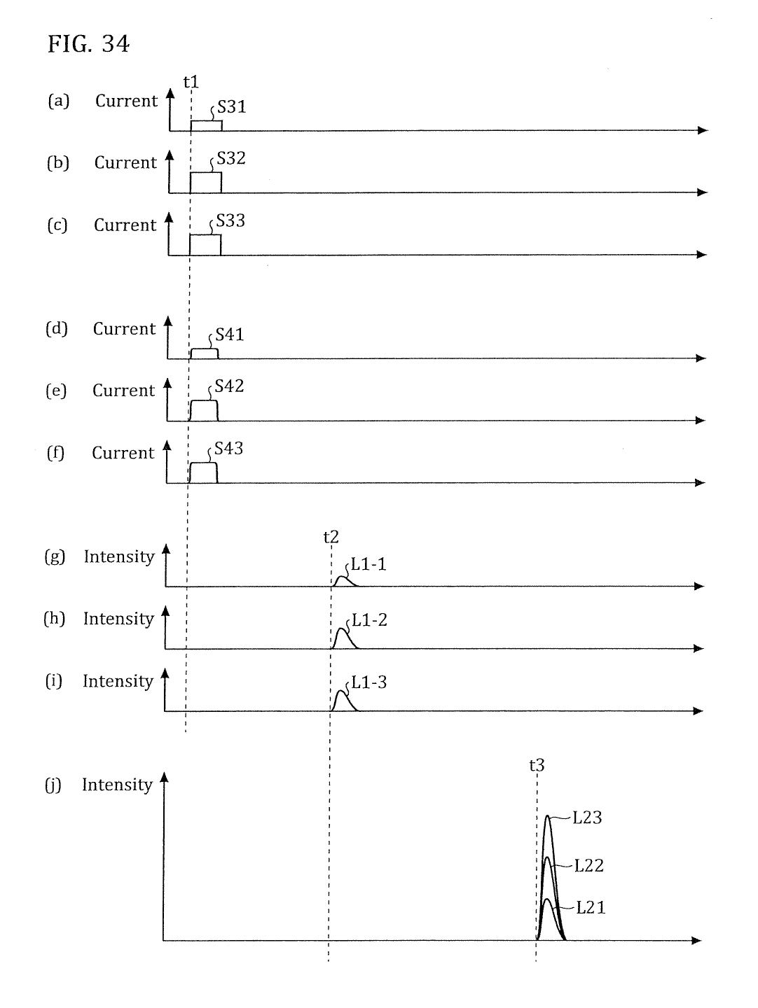

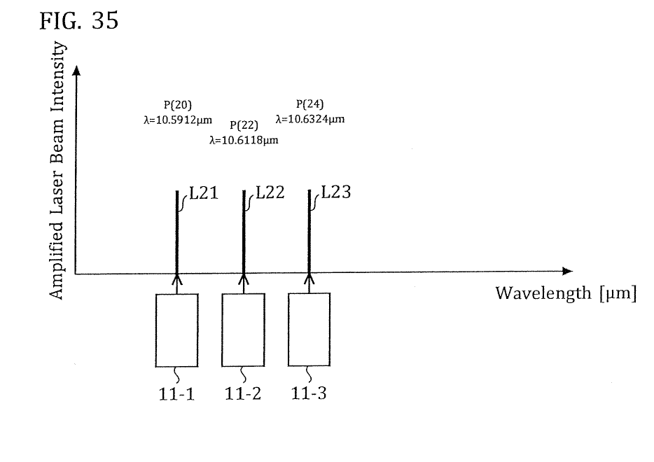

FIG. 34 is a timing chart showing the operation in accordance with the seventeenth embodiment. First, as shown in (a) through (c) in FIG. 34, oscillation triggers S31 through S33 are given to the semiconductor lasers 11-1 through 11-3 at the same timing t1. Note that the oscillation triggers S31 through S33 are given to a current driving unit (not shown) that inputs current pulses S41 through S43 to the semiconductor lasers 11-1 through 11-3. As shown in (d) through (f) in FIG. 34, the current driving unit inputs to the semiconductor lasers 11-1 through 11-3 the current pulses S41 through S43 of the intensity predetermined for the semiconductor lasers 11-1 through 11-3 or of the intensity corresponding to the current intensity of the oscillation triggers S31 through S33 at the timing t1 of the inputted oscillation triggers S31 through S33. Then, as shown in (g) through (i) in FIG. 34, the laser beams L1-1 through L1-3 of the intensity corresponding to the intensity of the current pulses S31 through S33 are outputted from the semiconductor lasers 11-1 through 11-3 at timing t2. These laser beams L1-1 through L1-3 are combined by the beam combiner 12. Thereafter, the combined laser beams L1-1 through L1-3 are amplified in the laser amplification unit 25, whereby superimposed laser beams L21 through L23 are outputted at timing t3, as shown in (j) in FIG. 34. It should be noted that the wavelengths of the laser beams L21 through L23 correspond to the gain bandwidths S2 through S4, as shown in FIG. 35.

### Eighteenth Embodiment

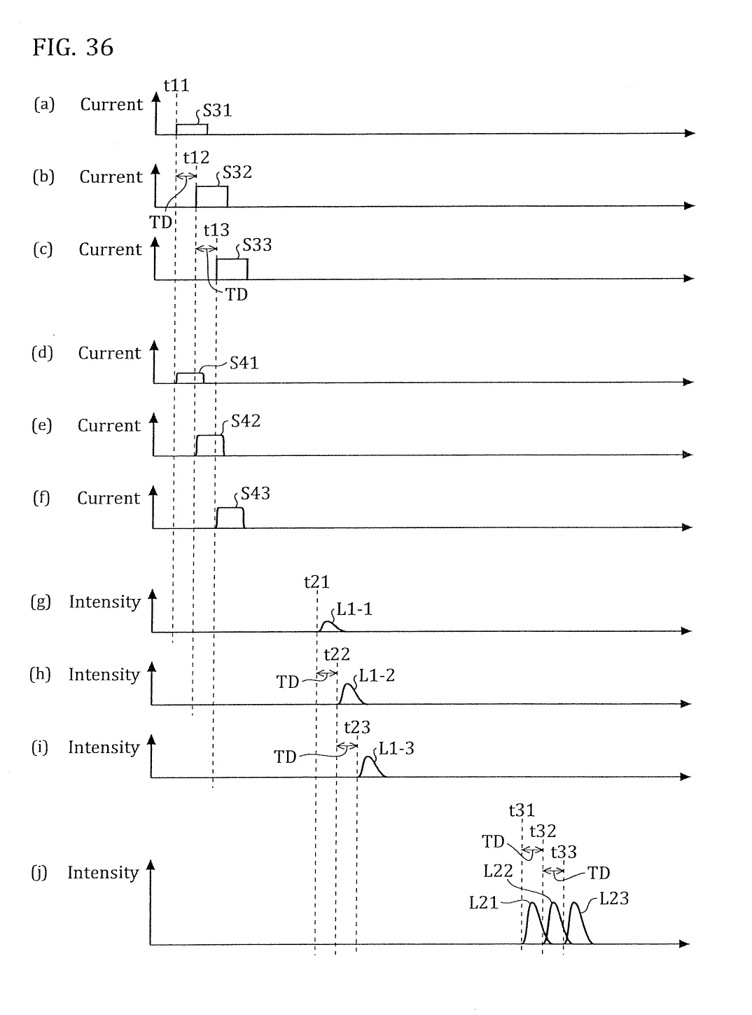

Further, in each of the embodiments described above, the plurality of the semiconductor lasers 11-1 through 11-n may output the respective laser beams L1-1 through L1-n at differing timing. As shown in (a) through (c) in FIG. 36, for example, timing at which the oscillation triggers S31 through S33 are given to the respective semiconductor lasers 11-1 through 11-3 may be set to timing t11 through t13 that are each offset by a time TD. In this case, as shown in (d) through (f) in FIG. 36, the timing at which the current pulses S41 through S43 are inputted to the respective semiconductor lasers 11-1 through 11-3 are also each offset by the time TD, whereby the timing at which the semiconductor lasers 11-1 through 11-3 output the respective laser beams L1-1 through L1-3 are set to timing t21 through t23 that are each offset by the time TD, as shown in (g) through (i) in FIG. 36. As a result, as shown (j) in FIG. 36, the combined amplified laser beam is a laser beam in which the amplified laser beams L21 through L23 that are each offset by the time TD are superimposed on one another.

Other configurations, operations, and effects are similar to those of the embodiments described above or the modifications thereof; thus, duplicate descriptions thereof will be omitted here.

The embodiments described above and the modifications thereof are merely examples for implementing this disclosure, and this disclosure is not limited thereto. Various modifications being made in accordance with specifications or the like is within the scope of this disclosure, and it is apparent that various other embodiments can be made from the above descriptions without departing from the scope of this disclosure. Further, the embodiments described above and the modifications thereof can be combined as desired.

Furthermore, the master oscillator system is a system which combines the semiconductor laser beams of at least one wavelength which can be amplified by the CO₂ gas gain medium, but without being limited thereto, at least one of the plurality of the semiconductor lasers may oscillate a laser beam of a wavelength that differs from the laser beams outputted from the other semiconductor lasers, of which the wavelengths may be identical. Here, the oscillation wavelengths of the semiconductor lasers coincide with the wavelengths of the plurality of amplification regions of the CO₂ laser amplifier.

The above descriptions are merely illustrative and not limiting. Accordingly, it is apparent to those skilled in the art that modifications can be made to the embodiments of this disclosure without departing from the scope of this disclosure.

The terms used in this specification and the appended claims should be interpreted as “non-limiting.” For example, the terms “include” and “be included” should be interpreted as “not limited to the stated elements.” The term “have” should be interpreted as “not limited to the stated elements.” Further, the modifier “one (a/and)” should be interpreted as at least one or “one or more.”

1. A laser device, comprising:
a diffraction grating; and
a plurality of semiconductor lasers disposed such that laser beams outputted therefrom are incident on the diffraction grating and at least one of diffraction beams of each laser beam travels in a predetermined direction.

2. The laser device of claim 1, wherein the diffraction grating is a reflective diffraction grating.

3. The laser device of claim 1, wherein the diffraction grating is a transmissive diffraction grating.

4. The laser device of claim 1, wherein
the diffraction grating has a groove formed thereon, and
the groove is formed to such depth that a diffraction beam of a laser beam incident on the groove and a diffraction beam of a laser beam incident on a portion beside the groove have a phase difference of π.

5. The laser device of claim 1, wherein the predetermined direction is perpendicular to a surface of the diffraction grating from which the diffraction beam is outputted.

6. The laser device of claim 1, wherein the predetermined direction is inclined to a surface of the diffraction grating from which the diffraction beam is outputted.

7. The laser device of claim 1, wherein the plurality of the semiconductor lasers is a quantum cascade laser.

8. The laser device of claim 1, wherein the diffraction grating collimates a diffraction beam of a laser beam incident thereon with divergence.

9. The laser device of claim 1, wherein the diffraction grating focuses a diffraction beam of a laser beam incident thereon.

10. The laser device of claim 9, further comprising an optical fiber with an input end thereof disposed substantially at a focal position of the diffraction beam, the focusing position being in the predetermined direction downstream of the diffraction grating.

11. A laser device, comprising:
at least one optical element having a focal position;
a diffraction grating disposed substantially at the focal position of the at least one optical element; and
a plurality of semiconductor lasers disposed such that laser beams outputted therefrom are incident on the at least one optical element, the laser beams outputted from the at least one optical element are incident on the diffraction grating, and at least one of diffraction beams of each laser beam travels in a predetermined direction.

12. The laser device of claim 11, wherein the diffraction grating is a reflective diffraction grating.

13. The laser device of claim 11, wherein the diffraction grating is a transmissive diffraction grating.

14. The laser device of claim 11, wherein the at least one optical element is a collimator lens.

15. The laser device of claim 11, wherein the at least one optical element is a concave mirror.

16. The laser device of claim 11, wherein
the diffraction grating has a groove formed thereon, and
the groove is formed to such depth that a diffraction beam of a laser beam incident on the groove and a diffraction beam of a laser beam incident on a portion beside the groove have a phase difference of π.

17. The laser device of claim 11, wherein the predetermined direction is perpendicular to a surface of the diffraction grating from which the diffraction beam is outputted.

18. The laser device of claim 11, wherein the predetermined direction is inclined to a surface of the diffraction grating from which the diffraction beam is outputted.

19. The laser device of claim 11, wherein the plurality of the semiconductor lasers is a quantum cascade laser.

20. The laser device of claim 11, wherein the diffraction grating collimates a diffraction beam of a laser beam incident thereon with divergence.

21. The laser device of claim 11, wherein the diffraction grating focuses a diffraction beam of a laser beam incident thereon.

22. The laser device of claim 21, further comprising an optical fiber with an input end thereof disposed substantially at a focusing position of the diffraction beam, the focusing position being in the predetermined direction downstream of the diffraction grating.

23. The laser device of claim 11, further comprising
a focusing optical system disposed in the predetermined direction downstream of the diffraction grating, and
an optical fiber with an input end thereof disposed substantially at a focal position of the focusing optical system.

24. A laser device, comprising:
at least one optical element having a focal position;
a diffraction grating disposed substantially at the focal position of the at least one optical element;
a plurality of semiconductor lasers; and
a plurality of optical fibers each having one end thereof being connected to a corresponding output end of the plurality of the semiconductor lasers, the plurality of the optical fibers being disposed such that laser beams outputted therefrom are incident on the at least one optical element, the laser beams outputted from the at least one optical element are incident on the diffraction grating, and at least one of diffraction beams of each laser beam travels in a predetermined direction.

25. The laser device of claim 24, wherein the diffraction grating is a reflective diffraction grating.

26. The laser device of claim 24, wherein the diffraction grating is a transmissive diffraction grating.

27. The laser device of claim 24, wherein the at least one optical element is a collimator lens.

28. The laser device of claim 24, wherein the at least one optical element is a concave mirror.

29. The laser device of claim 24, wherein
the diffraction grating has a groove formed thereon, and
the groove is formed to such depth that a diffraction beam of a laser beam incident on the groove and a diffraction beam of a laser beam incident on a portion beside the groove have a phase difference of π.

30. The laser device of claim 24, wherein the predetermined direction is perpendicular to a surface of the diffraction grating from which the diffraction beam is outputted.

31. The laser device of claim 24, wherein the predetermined direction is inclined to a surface of the diffraction grating from which the diffraction beam is outputted.

32. The laser device of claim 24, wherein the plurality of the semiconductor lasers is a quantum cascade laser.

33. The laser device of claim 24, wherein the diffraction grating collimates a diffraction beam of a laser beam incident thereon with divergence.

34. The laser device of claim 24, wherein the diffraction grating focuses a diffraction beam of a laser beam incident thereon.

35. The laser device of claim 24, further comprising an optical fiber with an input end thereof disposed substantially at a focusing position of the diffraction beam, the focusing position being in the predetermined direction downstream of the diffraction grating.

36. The laser device of claim 24, further comprising
a focusing optical system disposed in the predetermined direction downstream of the diffraction grating, and
an optical fiber with an input end thereof disposed substantially at a focal position of the focusing optical system.

37. A laser system, comprising:
a laser device including
a diffraction grating, and
a plurality of semiconductor lasers disposed such that laser beams outputted therefrom are incident on the diffraction grating and at least one of diffraction beams of each laser beams travels in a predetermined direction; and
at least one amplifier disposed downstream of the laser device for amplifying a laser beam outputted from the laser device.

38. The laser system of claim 37, wherein
the at least one amplifier includes a plurality of amplifiers, and
at least one of the plurality of the amplifiers is a regenerative amplifier.

39. The laser system of claim 37, wherein at least one wavelength of laser beams outputted from the plurality of the semiconductor lasers corresponds to at least one of a plurality of gain bandwidths of the at least one amplifier.

40. The laser system of claim 39, wherein at least one of the plurality of the semiconductor lasers oscillates a laser beam of a wavelength which differs from a wavelength of a laser beam outputted from another semiconductor laser among the plurality of the semiconductor lasers.

41. The laser system of claim 39, wherein at least one of the plurality of the semiconductor lasers outputs a laser beam of intensity which differs from intensity of a laser beam outputted from another semiconductor laser among the plurality of the semiconductor lasers.

42. The laser system of claim 39, wherein at least one of the plurality of the semiconductor lasers oscillates a pulsed laser beam at timing which differs from timing at which another semiconductor laser among the plurality of the semiconductor lasers oscillates a pulsed laser beam.

43. A laser system, comprising:
a laser device including
at least one optical element having a focal position,
a diffraction grating disposed substantially at the focal position of the at least one optical element, and
a plurality of semiconductor lasers disposed such that laser beams outputted therefrom are incident on the at least one optical element, the laser beams outputted from the at least one optical element are incident on the diffraction grating, and at least one of diffraction beams of each laser beam travels in a predetermined direction; and
at least one amplifier disposed downstream of the laser device for amplifying a laser beam outputted from the laser device.

44. A laser system, comprising:
a laser device including
at least one optical element having a focal position,
a diffraction grating disposed substantially at the focal position of the at least one optical element,
a plurality of semiconductor lasers, and
a plurality of optical fibers each having one end thereof being connected to a corresponding output end of the plurality of the semiconductor lasers, the plurality of the optical fibers being disposed such that laser beams outputted therefrom are incident on the at least one optical element, the laser beams outputted from the at least one optical element are incident on the diffraction grating, and at least one of diffraction beams of each laser beam travels in a predetermined direction; and
at least one amplifier disposed downstream of the laser device for amplifying a laser beam outputted from the laser device.

45. An extreme ultraviolet light generation apparatus, comprising:
the laser system including
a laser device which has a diffraction grating and a plurality of semiconductor lasers, the plurality of the semiconductor lasers being disposed such that laser beams outputted therefrom are incident on the diffraction grating and at least one of diffraction beams of each laser beams travels in a predetermined direction, and
at least one amplifier disposed downstream of the laser device for amplifying a laser beam outputted from the laser device;
a chamber provided with an inlet for introducing a laser beam outputted from the laser system into the chamber;
a focusing optical system for focusing the laser beam in a predetermined region inside the chamber;
a target supply unit provided to the chamber for supplying a target material to the predetermined region inside the chamber; and
a collector mirror disposed inside the chamber for collecting light of a predetermined wavelength emitted when the target material is irradiated with the laser beam in the predetermined region.

46. An extreme ultraviolet light generation apparatus, comprising:
the laser system including
a laser device which has at least one optical element having a focal position, a diffraction grating disposed substantially at the focal position of the at least one optical element, and a plurality of semiconductor lasers, the plurality of the semiconductor devices being disposed such that laser beams outputted therefrom are incident on the at least one optical element, the laser beams outputted from the at least one optical element are incident on the diffraction grating, and at least one of diffraction beams of each laser beam travels in a predetermined direction, and
at least one amplifier disposed downstream of the laser device for amplifying a laser beam outputted from the laser device;
a chamber provided with an inlet for introducing a laser beam outputted from the laser system into the chamber;
a focusing optical system for focusing the laser beam in a predetermined region inside the chamber;
a target supply unit provided to the chamber for supplying a target material to the predetermined region inside the chamber; and
a collector mirror disposed inside the chamber for collecting light of a predetermined wavelength emitted when the target material is irradiated with the laser beam in the predetermined region.

47. An extreme ultraviolet light generation apparatus, comprising:
the laser system including
a laser device which has at least one optical element having a focal position, a diffraction grating disposed substantially at the focal position of the at least one optical element, a plurality of semiconductor lasers, and a plurality of optical fibers each having one end thereof being connected to a corresponding output end of the plurality of the semiconductor lasers, the plurality of the optical fibers being disposed such that laser beams outputted therefrom are incident on the at least one optical element, the laser beams outputted from the at least one optical element are incident on the diffraction grating, and at least one of diffraction beams of each laser beam travels in a predetermined direction, and
at least one amplifier disposed downstream of the laser device for amplifying a laser beam outputted from the laser device;
a chamber provided with an inlet for introducing a laser beam outputted from the laser system into the chamber;
a focusing optical system for focusing the laser beam in a predetermined region inside the chamber;
a target supply unit provided to the chamber for supplying a target material to the predetermined region inside the chamber; and
a collector mirror disposed inside the chamber for collecting light of a predetermined wavelength emitted when the target material is irradiated with the laser beam in the predetermined region.

48. An extreme ultraviolet light generation apparatus, comprising:
the laser system including
a laser device which has a diffraction grating, and a plurality of semiconductor lasers disposed such that laser beams outputted therefrom are incident on the diffraction grating and at least one of diffraction beams of each laser beams travels in a predetermined direction, at least one of the plurality of the amplifiers being a regenerative amplifier, and
at least one amplifier disposed downstream of the laser device for amplifying a laser beam outputted from the laser device, the at least one amplifier including a plurality of amplifiers;
a chamber provided with an inlet for introducing a laser beam outputted from the laser system into the chamber;
a focusing optical system for focusing the laser beam in a predetermined region inside the chamber;
a target supply unit provided to the chamber for supplying a target material to the predetermined region inside the chamber; and
a collector mirror disposed inside the chamber for collecting light of a predetermined wavelength emitted when the target material is irradiated with the laser beam in the predetermined region.
